(19) United States
(12) Patent Application Publication
(10) Pub. No.: US 2022/0054964 A1
(43) Pub. Date: Feb. 24, 2022

(54) FILTER MEDIA STRUCTURES

(71) Applicant: Ascend Performance Materials Operations LLC, Houston, TX (US)

(72) Inventors: Vikram GOPAL, Houston, TX (US); Natasha DEAN, Houston, TX (US); Albert ORTEGA, Houston, TX (US); Wai-shing YUNG, Houston, TX (US); Ping HAO, Houston, TX (US)

(73) Assignee: Ascend Performance Materials Operations LLC, Houston, TX (US)

(21) Appl. No.: 17/408,131

(22) Filed: Aug. 20, 2021

Related U.S. Application Data
(60) Provisional application No. 63/068,692, filed on Aug. 21, 2020.

(51) Int. Cl. B01D 46/00; B01D 39/16

(52) U.S. Cl. CPC B01D 46/0028; B01D 39/1623; B01D 46/0032; B01D 2275/10; B01D 2239/0442; B01D 2239/0618; B01D 2239/1233; B01D 2239/0435

(57) ABSTRACT

Provided herein are filter media structures having antimicrobial and/or antiviral properties. In particular, the present disclosure describes filter media structures having a first layer with an electret web and a second layer that demonstrates biological-reducing properties. In some cases, the first layer is formed from polypropylene (e.g., spunbond) and the second layer is formed from a plurality of fibers of a polyamide composition (e.g., meltblown).

### CROSS-REFERENCE TO RELATED APPLICATIONS

This application claims priority to U.S. Provisional Application No. 63/068,692, filed Aug. 21, 2020, which is incorporated herein by reference.

### TECHNICAL FIELD

The present disclosure relates to filter media structures having biological-reducing properties, which includes antiviral, antibacterial, antifungal, and/or antimicrobial properties. In particular, the present disclosure provides configurations of filter media structures having at least one layer with biological-reducing components.

### BACKGROUND

The common filtration process removes particulates from fluids, such as an air stream or other gaseous stream or from a liquid stream such as a hydraulic fluid, lubricant oil, fuel, water stream or other fluids. Filter media structures generally fit into two broad categories: surface-type filters, which stop contaminants on the surface, and depth-type filters, which capture contaminants therein. Regardless of the category, filtration processes require mechanical strength as well as chemical and physical stability. The filter media can be exposed to a broad range of temperature, humidity, mechanical vibration and shock conditions, and to both reactive and non-reactive, abrasive or non-abrasive particulates that are entrained in the fluid flow. Filters may be removed for service and cleaned in aqueous or non-aqueous cleaning compositions. Such filter media are often manufactured by spinning or melt blowing one fiber layer (fine fiber) and then forming another interlocking web (microfiber) on the porous substrate. In the melt blowing process, the fiber can form physical bonds between fibers to interlock the fiber mat into an integrated layer. Such a material can then be fabricated into the desired filter format such as cartridges, flat disks, canisters, panels, bags and pouches. Within such structures, the media can be substantially pleated, rolled or otherwise positioned on support structures.

Often the stream passing through the filter media may contain harmful biology components, e.g., viruses, bacteria, mold, mildew, spores, fungi, microbials, or other microorganisms. This biology component can be small enough to pass through high efficiency filters. Existing filters capture such viruses and/or other microorganisms on the surface and/or within the fiber structure of the filter media. However, this has not been shown to be a complete solution for filtering biological components, in particular for filters that need robust or durable properties to remove biological components.

In an attempt to achieve such properties, conventional techniques have applied a number of treatments or coatings to fibers to impart antimicrobial properties to filters. Compounds containing copper, silver, gold, or zinc, either individually or in combination, have been used in these applications—in the form of a topical coating treatment—to effectively combat the pathogens. These types of antimicrobial fibers may be used in many different types of settings. However, these coated fibers have not demonstrated adequately durable antiviral properties. Furthermore, these coated fibers have struggled to meet many other requirements of these filtration applications.

U.S. Pat. No. 4,701,518 describes imparting antimicrobial activity to nylon during its preparation by adding to the nylon-forming monomer(s), a zinc compound (e.g. zinc ammonium carbonate) and a phosphorus compound (e.g. benzene phosphinic acid). The compounds are added in amounts sufficient to form in situ a reaction product containing at least 300 ppm of zinc, based on the weight of nylon prepared. Fibers made from the resulting nylon contain the reaction product uniformly dispersed therein and have antimicrobial activity of a permanent nature.

Although some references may teach the use of antimicrobial/antiviral filter, a need exists for filter media structure having biological-reducing properties and that is robust, durable and long-lasting. In addition, the filter media needs to have improved retention rates, and/or resistance to the extraction.

### SUMMARY

The present disclosure describes a filter media structure having biological-reducing properties that are robust, durable and long-lasting. In one embodiment the filter media structures described herein may demonstrates a bacterial filtration efficiency greater than 90% and/or a particulate filtration efficiency greater than 90%.

In one aspect, the disclosure describes a filter media structure for purifying a stream comprising a first layer, preferably an electret web, having a first surface and second surface, wherein the first layer comprises a polymer, preferably polyolefin, polyester, polyurethane, polycarbonate, polystyrene, fluoropolymer, or copolymers or blends thereof, and a second layer adjacent to the first surface, wherein second layer comprises from 50 to 99.9 wt. % of polymer fibrers, preferably polyamide fibers, based on the total weight of the second layer, each having a fiber diameter from 0.01 microns to 10 microns, from 1 wppm to 30,000 wppm of a metallic compound comprising copper, zinc, silver or combinations thereof, and, optionally less than 1 wt. % of a phosphorus compound, wherein at least one of the second layer demonstrates biological-reducing properties.

In another aspect, the disclosure describes filter media structure for purifying a stream comprising a first layer, wherein the first layer, preferably an electret web, comprises a polymer, preferably, polyolefin, polyester, polyurethane, polycarbonate, polystyrene, fluoropolymer, or copolymers or blends thereof, a second layer comprising from 50 to 99.9 wt. % of polymer fibers, preferably polyamide fibers, based on the total weight of the second layer, each having a fiber diameter from 0.01 microns to 10 microns, from 1 wppm to 30,000 wppm of a metallic compound comprising copper, zinc, silver or combinations thereof, and, optionally less than 1 wt. % of a phosphorus compound, wherein at least one of the second layer demonstrates biological-reducing properties; and a third layer, preferably a scrim, having a first and second surface, wherein the second layer is adjacent to the first surface of the third layer.

In another aspect, the disclosure describes filter media structure for purifying a stream comprising a first layer that is an electrically-charged nonwoven web having a first surface and second surface, wherein the first layer comprises a polymer, preferably polyolefin, polyester, polyurethane, polycarbonate, polystyrene, fluoropolymer, or copolymers or blends thereof; a second layer adjacent to the first surface, wherein second layer comprises from 50 to 99.9 wt. % of polymer fibers, preferably polyamide fibers, based on the total weight of the second layer, each having a fiber diameter from 0.01 microns to 10 microns, and from 1 wppm to 30,000 wppm of a metallic compound comprising copper, zinc, or silver, or combinations thereof, and wherein at least one of the second layer demonstrates biological-reducing properties.

In another aspect, the disclosure describes filter media structure a filter media structure for purifying a stream comprising a first layer having a first surface and second surface, wherein the first layer comprises a polymer, preferably polyolefin, polyester, polyurethane, polycarbonate, polystyrene, fluoropolymer, or copolymers or blends thereof; and a second layer adjacent to the first surface, wherein second layer is a spunbond layer that comprises from 50 to 99.9 wt. % of polymer fibers, preferably polyamide fibers, based on the total weight of the second layer, and from 1 wppm to 30,000 wppm of a metallic compound comprising copper, zinc, or silver, or combinations thereof, and wherein at least one of the second layer demonstrates biological-reducing properties. In one embodiment, the polymer fibers of the second layer each have a fiber diameter that is less than 25 microns, preferably from 0.01 microns to 10 microns.

### BRIEF DESCRIPTION OF THE DRAWINGS

The disclosure is described in detail below with reference to the appended drawings, wherein like numerals designate similar parts.

FIGS. 1A and 1B illustrates a configuration of a filter media structure having at two layers according to the present disclosure.

FIGS. 2A-2D illustrates a configuration of a filter media structure having third layers according to the present disclosure.

### DETAILED DESCRIPTION

### Introduction

Filter media structures composed of fibrous and/or porous materials are designed to prevent or reduce the passage of some particulate in stream. For example, a filter media structure may be designed to remove solid particulates, such as dust, pollen, or mold, from the stream. A filter media structure may also be designed to mechanically remove pathogens, such as bacteria, viruses or microbes, from the stream, e.g., based on pore size. The material and configuration of the filter media structure may vary widely, and in many cases a filter media structure may be specifically designed to target the removal of one or more specific particulates. Numerous applications utilize filter media structures. For example, a filter media structure may be utilized as an air filter, e.g., in a high efficiency particulate air (HEPA) filter, a heating, ventilation, and air conditioning (HVAC) filter, or an automotive cabin filter.

Conventional filter media structure, however, rely on physical and mechanical filtration, e.g., structures/configurations with pores and/or passageways that physically prohibit passage of some particles while allowing passage to others.

The filter media structures of the present disclosure advantageously utilize one or more layers that, in addition to relying on physical filtration properties, also provide biological-reducing properties, which may include biological-destroying properties. Biological-reducing properties include, but are not limited to, antimicrobial and/or antiviral (AM/AV) properties as well as antifungal, antimold, or anti-mildew properties. Stated another way, the disclosed filter media structures not only protect by limiting pathogen intake by physical or mechanical means, they also destroy pathogens via contact with the AM/AV layer(s) before the pathogens can pass therethrough. The AM/AV properties are made possible, at least in part, by the composition of the fibers in at least one of the layers in the filter media structure. The layers contain a polymer component along with an AM/AV compound, which in some cases, is embedded in the polymer structure. The term “AM/AV compound” is not meant to limit the characteristics thereof to only include AM and AV properties—other properties, e.g., antifungal or antimold properties, are contemplated. The presence of the AM/AV compound in the polymers of the fibers provides for the pathogen-destroying properties. As a result, the disclosed items prevent transmission of pathogens from contact that otherwise would allow the pathogen to spread. Importantly, because the AM/AV compound may be embedded in the polymer structure, the AM/AV properties are durable, and are not easily worn or washed away. Thus the filter media structure can be employed for a long-term filtration and reduces replacement. The composition of the fibers, and layers is discussed in more detail herein. And the methods of producing the fibers, and layers, e.g., spin bonding, melt blowing, electrospinning, inter alia, are discussed in more detail herein. Other production processes are contemplated, including textile spinning and weaving.

As noted above, the present disclosure provides novel compositions and configurations for filter media structures. In particular, the filtration device may use the filter media structures that comprise multiple layers: a first layer, a second layer, and, optionally, a third layer. At least one of the layers demonstrate the AM/AV properties (or other beneficial properties). That is to say, at least one of the layers has the ability to reduce, prevent, inhibit and/or destroy pathogens that come into contact with the layer. As a result, the AM/AV filter media structures provide for the aforementioned benefits. As is discussed in detail below, the biological-destroying properties of the filter media structures may be derived from the use of a polymer composition demonstrating antimicrobial and/or antiviral properties.

The present disclosure encompasses several configurations of the filter media structures. In addition to the AM/AV properties, the configurations exhibit varying levels of physical filtration performance characteristics (e.g., fluid resistance, particulate filtration efficiency, bacterial filtration efficiency, breathability, and flammability). As such, the filter media structures of the present disclosure may be configured to satisfy various NIOSH and/or ASTM standards. In some embodiments, the filter media structures satisfy ASTM Level I, Level II, and/or Level III standards. In some embodiments, for example, the filter media structures described herein satisfy HEPA or MERV standards.

In some cases, the disclosure relates to the material from which the layers are formed, e.g., to the fibers or filter layers. The fibers or filter layers may be produced as discussed herein and collected in bulk, e.g., in high quantities on rolls. The rolled filter layers may then be further processed to produce the disclosed filter media structures.

### Filter Media Structure

The filter media structures of the present disclosure include multiple layers. In particular, the filter media structures comprise a first layer and a second layer. In some embodiments, the first layer is an electret web and the second layer demonstrates biological-reducing properties. In some embodiments, the filter media structure includes an additional third layer, which may be a scrim or supporting layer. Generally it is preferred that the scrim provide high flow while providing adequate strength. In some embodiments, the layers of the filter media structure are arranged such that at least one surface of the first layer is adjacent to the second layer, in a downstream or upstream position. In some embodiments, the layers of the filter media structure are arranged such that at least a portion of the second layer is adjacent to the third layer. In some cases, the layers of the filter media structures are arranged such that the second layer is disposed between the first layer and the third layer, e.g., the second layer is sandwiched between the first and third layers.

In some embodiments, the filter media structures may comprise additional layers, which may be similar to or distinct from each of the first, second, and third layers. Said another way, in some cases, other layers may also be included in the filter media structures. In embodiments with additional layers, the second layer may not necessarily be in direct contact with the other layers. That is to say, “disposed between” (e.g., the second layer is disposed between the first layer and the third layer) does not necessarily mean “in contact with.” In some cases, the layers may be made up of sublayers, e.g., multiple sublayers may be combined to form one of the primary layers. Sublayers are discussed in more detail below.

Importantly, at least one of the layers may be comprised of fibers that have biological-reducing properties (AM/AV properties) discussed herein. For purposes of this disclosure, at least the second layer demonstrates biological-reducing properties. As such, these layers have the capability to kill, destroy, neutralize, or inhibit pathogens that contact the layer(s). For example, the layer may be constructed of AM/AV fibers, and this layer may destroy pathogens that pass through, thus providing superior AM/AV performance. When positioned upstream, the layer constructed of AM/AV fibers may interact pathogens in the stream before passing through the other layers. This can reduce the entrapment of pathogens in the other layers.

In some cases, the first layer, the second layer, and the third layer are coextensive. As used herein, the term “coextensive” refers to a relationship between two or more layers such that the surface areas of adjacent or parallel faces of the layers are aligned with one another with little or no overhang (of at least one of the areas or layers). In some cases the extents of the areas or faces are within 90% of one another. For example, two or more layers are coextensive if the surface areas of adjacent or parallel faces of the layers are within 90%, within 92%, within 94%, within 96%, or within 98% of one another. The term “coextensive” can also refer to a relationship between two or more layers such that the lengths of the layers are within 90% of one another. For example, two or more layers are coextensive if the lengths of the layers are within 90%, within 92%, within 94%, within 96%, or within 98% of one another. The term “coextensive” can also refer to a relationship between two or more layers such that the widths of the layers are within 90% of one another. For example, two or more layers are coextensive if the widths of the layers are within 90%, within 92%, within 94%, within 96%, or within 98% of one another.

Each of the first layer, the second layer, and the third layer have opposing surfaces. Each layer may be positioned adjacent or in contact with another along the surface. The configuration of the filter media structure is based on the positioning of the second layer that may be upstream or downstream of the first layer. Other layers may also be present between the layers.

In some embodiments, the second layer is formed directly on the first layer. For example, the first layer may comprise polyolefin, polyester, or polystyrene, and the second layer may comprise polymer fibers, preferably polyamide fibers, which are blown directly on a surface of the first layer. In this way, the first layer and the second layer may be (substantially) contiguous.

In some embodiments, the layers of the filter media structure are separable and/or removable. For example, the second layer may be removable from the filter media structure. This may allow for individual components to be washed and/or replaced. In some cases, for example, the first layer and/or the third layer form a sleeve that surrounds the second layer, which can be removed or replaced.

In some embodiments, a layer or layers of the filter media structure may be configured to surround a conventional filter media structure during use. For example, the first layer and/or the second layer may be applied on either side of an existing (e.g., conventional) media. As a result, the filter media structure may impart biological-reducing properties (AM/AV properties) to an existing filter, which previously did not have such capabilities.

In some embodiments, the disclosed filter media structures may be employed in conjunction with a respirator apparatus. In some cases, the filter media structures can be used in the respirator in a replacement manner, e.g., to replace one another or to replace original filter media.

### First Layer

Generally, the first layer is designed to filter the stream (air and/or liquid) that passes through the filter media structure. The first layer is capable of isolating, trapping, and/or otherwise removing a particulate (e.g., a dust, pollen, mold, fungus, or a pathogen). As such, the first layer purifies the stream passing through the filter media structure.

In some cases, the disclosed filter media structures comprise a first layer that is an electrically-charged nonwoven web, which is known as an electret web. The electric charge enhances the ability of the first layer to capture particles that are suspended in the stream. The electric charge may be present on the fibers of the first layer for more than a transitory duration for stability (quasi-permanent electric charge) and for purposes of the present invention the charge is not reduced by the present of the second layer having the biological-reducing properties.

The electrostatic charge of the first layer may be up to −20 kV. The first layer may have a generally uniform charge distribution throughout the web. In some embodiments, the first layer may comprise a charge additives, such as divalent metal-containing salts or triazine compounds, which are widely used.

The composition of the first layer may vary include a suitable (thermoplastic) polymer. Polymers suitable for the first layer may include polyolefins, polyesters, polyurethanes, polycarbonates, polystyrenes, fluoropolymers, or copolymers or blends thereof. In one embodiment, the polymer for the first layer may comprises polyethylene (PE), polypropylene (PP), polybutylene (PB), poly-4-methylpentene (PMP), polyethylene terephthalate (PET), polybutylene terephthalate (PBT), polytrimethyl terephthalate (PTT), poly (ethylene-vinyl acetate) (PEVA), polyvinyl chloride (PVC), polystyrene (PS), polymethylmethacrylate (PMMA), polytrifluorochloroethylene (PCTFE), or combinations thereof. In some embodiments, the first layer may comprise two or more of these polymers that are blends or stacked together as multiple layers (two-ply), which is common in making filter media. For examples, the first layer may comprise PE, PP, or PB that is stacked together with PET, PBT, or PTT. The first layer is a nonwoven layer such as a spunbond nonwoven, a meltblown nonwoven, an adhesive bonded nonwoven or needle felt nonwoven. The charge may be applied to the first layer using any suitable technique, such as corona charging, tribocharging, or hydrocharging.

In some embodiments, the first layer may comprise staple fibers to provides a more lofty, less dense web. The amount of staple fibers in the first layer may be generally no more than about 90 wt. %, based on the total weight of the first layer, no more than about 80 wt. %, no more than about 75 wt. %, no more than about 70 wt. %, no more than about 50 wt. %, no more than about 25 wt. %, no more than about 10 wt. %, no more than about 5 wt. %, no more than about 1 wt. %, or no more than about 0.5 wt. %.

To be used as an electret web the thermoplastic polymers in the first layer may have an average fiber diameter from about 1 to 100 micrometers, e.g., about 1 to 75 micrometers, about 1 to 50 micrometers, about 1 to 40 micrometers, about 1 to 35 micrometers, about 1 to 30 micrometers, about 1 to 25 micrometers, about 1 to 20 micrometers, or about 1 to 15 micrometers. The lower range may be about 1 micrometer or more, e.g., about 1.5 micrometer or more, about 2 micrometer or more, about 5 micrometer or more, about 7 micrometer or more, or about 10 micrometer or more.

In some embodiments, the first layer may comprise a sorbent particulate material such as activated carbon or alumina. The sorbent particulate material may be present in amounts up to about 80 volume percent based on the total content of the first layer, e.g., up to about 70 percent, up to about 60 percent, up to about 50 percent, up to about 40 percent, up to about 30 percent, up to about 20 percent, up to about 10 percent, up to about 5 percent, or up to about 1 percent.

In addition, the first layer may also comprise various optional additives including, for example, pigments, light stabilizers, primary and secondary antioxidants, metal deactivators, fluorine-containing compounds and combinations thereof. These additives may be blended with the thermoplastic polymer of the first layer.

The basis weight of the first layer can be controlled through processing techniques, such as changing either the collector speed or the die throughput. In some embodiments, the first layer generally have a basis weight (mass per unit area) in the range of about 10 to 500 g/m², and in some embodiments, about 10 to 100 g/m². Thus, the basis weight of the first layer may vary widely. In one embodiment, the first layer has a basis weight from 10 g/m² to 495 g/m², e.g., from 10 g/m² to 450 g/m², from 10 g/m² to 400 g/m², from 10 g/m² to 350 g/m², from 10 g/m² to 300 g/m², 10 g/m² to 250 g/m², from 10 g/m² to 200 g/m², from 10 g/m² to 175 g/m², from 10 g/m² to 150 g/m². In terms of lower limits, the basis weight of the first layer may be greater than or equal to 10 g/m², e.g., greater than or equal to 15 g/m², greater than or equal to 20 g/m², greater than or equal to 25 g/m², greater than or equal to 30 g/m². In some embodiments, when the first layer comprises multiple layers of polymers stacked together, the combined basis weight of all layers is greater than or equal to 10 g/m², even though the individual layers may be less than 10 g/m².

The solidity of the first layer typically is about 1% to 65%, e.g., about 1% to 50%, about 1% to 40%, about 1% to 35%, about 1% to 25%, about 1% to 20%, or more typically about 3% to 10%. Solidity is a unit less parameter that defines the solids fraction of the first layer.

In some embodiments, the thickness of the first layer as measured in an planar configuration, is generally larger than the second layer, e.g., at least twice as large or at least three times as large. The thickness of the first layer can vary with intended use, and preferably low thickness is desired in a number of filtration application. The thickness of the first layer may be from about 0.1 to 20 millimeters, e.g., from about 0.25 to 20 millimeters, from about 0.25 to 15 millimeters, from about 0.25 to 10 millimeters, from about 0.25 to 5 millimeters, from about 0.25 to 2.5 millimeters, from about 0.5 to 2 millimeters.

In some embodiments, the first layer may have a structure as a flat, waved or pleated web. The first layer, as well as the entire filter media structure, may be folded or formed into a circular body. The first layer can be shaped, such as pleated, without losing its structural integrity or filtration performance.

The first layer is capable of removing particulates and/or pollutants from the stream. In particular, first layer is capable of removing particles with diameters of less than 2.5 micrometers (PM_{2.5}) also known as fine particles. Pollutants can arise from a number of sources and include volatile organic compounds (“VOCs”), such as formaldehyde.

Minimum Efficiency Reporting Value (MERV) ratings are used by the filtration industry to classify a filter's performance for different intended uses, including the ability to remove particulates from the stream. The MERV rating is derived from the efficiency of the filter versus particles in various size ranges, and is calculated according to methods detailed in ASHRAE 52.2. In some embodiments, the first layer alone has an initial MERV rating that is in the range of about 7 to 15, e.g., from 10 to 15, from 12 to 15 or from 13 to 15. As discuss further herein the second layer having biological-reducing properties is advantageous to increase the initial MERV rating.

### Second Layer

The disclosed filter media structures include a second layer, which may comprise a nonwoven layer. Similar the first layer, the second layer is capable of filtering the stream (air and/or liquid) that passes through the filter media structure. In addition, the second layer demonstrates biological-reducing (AM/AV) properties without impairing the ability of the first layer to function. As a result, the second layer may prevent transmission of bacterial, microbes, virus, pathogens, fungi, and other biological components by removing such components from the stream.

The polymer composition of the second layer may vary widely. In one embodiment, the polymer for the second layer may comprises polyamide (PA), polyethylene (PE), polypropylene (PP), polybutylene (PB), poly-4-methylpentene (PMP), polyethylene terephthalate (PET), polybutylene terephthalate (PBT), polytrimethyl terephthalate (PTT), poly (ethylene-vinyl acetate) (PEVA), polyvinyl chloride (PVC), polystyrene (PS), polymethylmethacrylate (PMMA), or polytrifluorochloroethylene (PCTFE), or combinations thereof. In one embodiment, the second layer may be a nonwoven layer such as a spunbond layer, a meltblown nonwoven, an adhesive bonded nonwoven or needle felt nonwoven.

In some embodiments, the second layer and/or the fibers thereof are made from and/or comprises the polyamide composition described herein. In some cases, the second layer comprises a polyamide polymer made from the polyamide compositions described herein. The second layer may be a nonwoven layer. And due to the AM/AV compound in these polymer compositions, the second layer may have AM/AV properties.

The polyamide of the second layer, in some embodiments, comprise a combination of polyamides. By combining various polyamides, the second layer, as well as filter media structure, may be able to incorporate the desirable properties, e.g., mechanical properties, of each constituent polyamides. In one embodiment, the second layer comprises a polyamide composed mainly of hexamethylenediamine and adipic acid referred to as poly[imino(1,6-dioxohexamethylene) iminohexamethylene] or polyamide 66 (PA66). In one embodiment, the second layer comprises greater than 75 wt. % of PA66, e.g., greater than 80 wt. %, greater than 85 wt. %, greater than 87 wt. %, greater than 90 wt. %, greater than 91 wt. %, greater than 95 wt. %, or greater than 97 wt. %. In terms of ranges, the second layer contains from 75 to 99.5 wt. % of PA66, e.g., from 75 to 98.5 wt. %, from 75 to 97.5 wt. %, from 75 to 95 wt. %, from 75 to 90 wt. %, or from 75 to 87 wt. %.

In some embodiment, the second layer comprises a polyamide containing caprolactam and preferably is primarily caprolactam and contains more than 90% of caprolactam, e.g., more than 95% or more than 97%. A preferred polyamide containing caprolactam is poly(azepan-2-one), also known as polyamide 6 (PA6). Other cyclic, aromatic and long chain alkyl polyamides may also be used with embodiments of the present invention. Thus, in some embodiments, the polyamide of the second layer comprises PA-4T/4I, PA-4T/6I, PA-5T/5I, PA-6, PA-6,6, PA-6,6/6, PA-6,6/6T, PA-6T/6I, PA-6T/6I/6, PA-6T/6, PA-6T/6I/66, PA-6T/MPMDT, PA-6T/66, PA-6T/610, PA-10T/612, PA-10T/106, PA-6T/612, PA-6T/10T, PA-6T/10I, PA-9T, PA-10T, PA-12T, PA-10T/10I, PA-10T/12, PA-10T/11, PA-6T/9T, PA-6T/12T, PA-6T/10T/6I, PA-6T/6I/6, or PA-6T/61/12, or copolymers thereof, or blends, mixtures or combinations thereof. Combinations of these polyamides may be employed, such as but not limited to PA6/66, PA66/6T, PA66/6I. In these embodiments, the polyamide may comprise from 1 wt. % to 99 wt. % PA-6, from 30 wt. % to 99 wt. % PA-6,6, and from 1 wt. % to 99 wt. % PA-6,6/6T. In some embodiments, the polyamide comprises one or more of PA-6, PA-6,6, and PA-6,6/6T. In some aspects, the polymer composition comprises 6 wt. % of PA-6 and 94 wt. % of PA-6,6. In some aspects, the polymer composition comprises copolymers or blends of any of the polyamides mentioned herein.

The second layer may also comprise polyamides produced through the ring-opening polymerization or polycondensation, including the copolymerization and/or copolycondensation, of lactams. Without being bound by theory, these polyamides may include, for example, those produced from propriolactam, butyrolactam, valerolactam, and caprolactam. For example, in some embodiments, the polyamide is a polymer derived from the polymerization of caprolactam. In those embodiments, the polymer comprises at least 10 wt. % caprolactam, e.g., at least 15 wt. %, at least 20 wt. %, at least 25 wt. %, at least 30 wt. %, at least 35 wt. %, at least 40 wt. %, at least 45 wt. %, at least 50 wt. %, at least 55 wt. %, or at least 60 wt. %. In some embodiments, the polymer includes from 10 wt. % to 60 wt. % of caprolactam, e.g., from 15 wt. % to 55 wt. %, from 20 wt. % to 50 wt. %, from 25 wt. % to 45 wt. %, or from 30 wt. % to 40 wt. %. In some embodiments, the polymer comprises less than 60 wt. % caprolactam, e.g., less than 55 wt. %, less than 50 wt. %, less than 45 wt. %, less than 40 wt. %, less than 35 wt. %, less than 30 wt. %, less than 25 wt. %, less than 20 wt. %, or less than 15 wt. %. Furthermore, the polymer composition may comprise the polyamides produced through the copolymerization of a lactam with a nylon, for example, the product of the copolymerization of a caprolactam with PA-6,6.

In some aspects, the polyamide can formed by conventional polymerization of the polymer composition in which an aqueous solution of at least one diamine-carboxylic acid salt is heated to remove water and effect polymerization to form an antiviral nylon. This aqueous solution is preferably a mixture which includes at least one polyamide-forming salt in combination with the specific amounts of a zinc compound, a copper compound, and/or an optional phosphorus compound described herein to produce a polymer composition. Conventional polyamide salts are formed by reaction of diamines with dicarboxylic acids with the resulting salt providing the monomer. In some embodiments, a preferred polyamide-forming salt is hexamethylenediamine adipate (nylon 6,6 salt) formed by the reaction of equimolar amounts of hexamethylenediamine and adipic acid.

In one embodiment, the second layer may be thinner than the first layer, preferably twice as thin, three times as thin, or thinner. By being thinner the second layer is particularly suited to provide a biological-reducing (AM/AV) properties without impairing the filtration of the first layer. In one embodiment, the second layer has a thickness of less than or equal to 10 mm, e.g., less than or equal to 9 mm, less than or equal to 8 mm, less than or equal to 7 mm, less than or equal to 6 mm, less than or equal to 5 mm, less than or equal to 4 mm, less than or equal to 3 mm, less than or equal to 2.5 mm, less than or equal to 2 mm, or less than or equal to 1 mm. Exemplary ranges of the thickness of the second layer may be from 0.03 to 10 mm, e.g., from 0.03 to 7 mm, from 0.05 to 7 mm, from 0.05 to 5 mm, from 0.05 to 2.5 mm, or from 0.05 to 1 mm.

The second layer may be a nonwoven composed of a plurality of fibers. The fibers of the second layer may have an average fiber diameter suitable for its intended uses. In some embodiments, the second layer comprises a plurality of microfibers (e.g., fibers having a diameter greater than or equal to 1 micron). In some embodiments, the second layer comprises a plurality of nanofibers (e.g., fibers having a diameter less than 1 micron). In some embodiments, the second layer comprises both microfibers and nanofibers. In some embodiments, the second layer comprises a plurality of fibers having an average fiber diameter of less than 1 micron, e.g., less than 0.9 microns, less than 0.8 microns, less than 0.7 microns, less than 0.6 microns, less than 0.5 microns, less than 0.4 microns, less than 0.3 microns, less than 0.2 microns, less than 0.1 microns, less than 0.05 microns, less than 0.04 microns, or less than 0.3 microns. In terms of lower limits, the average fiber diameter of the plurality of fibers may be greater than 1 nanometer, e.g., greater than 10 nanometers, greater than 25 nanometers, greater than 50 nanometers, greater than 100 nanometers, greater than 150 nanometers, greater than 200 nanometers or greater than 250 nanometers. In terms of ranges, the average fiber diameter of the plurality of fibers may be from 1 nanometer to 1000 nanometers, e.g., from 100 nanometers to 950 nanometers, from 100 nanometers to 900 nanometers, from 100 nanometers to 850 nanometers, from 100 nanometers to 800 nanometers, from 100 nanometers to 750 nanometers, from 100 nanometers to 700 nanometers, from 100 nanometers to 650 nanometers, from 200 nanometers to 650 nanometers, from 250 nanometers to 600 nanometers, from 250 nanometers to 550 nanometers, or from 300 nanometers to 550 nanometers.

In some embodiments, the second layer comprises a plurality of fibers having an average fiber diameter is less than 25 microns, e.g., less than 20 microns, less than 15 microns, less than 10 microns, or less than 5 microns. In terms of lower limits, the plurality of fibers may have an average fiber diameter greater than 1 micron, e.g., greater than 1.5 microns, greater than 2 microns, or greater than 2.5 microns. In terms of ranges, the plurality of fibers may have an average fiber diameter from 1 micron to 25 microns, e.g., from 1 micron to 20 microns, from 1 micron to 15 microns, from 1 micron to 10 microns, from 1 micron to 5 microns, from 1.5 microns to 25 microns, from 1.5 microns to 20 microns, from 1.5 microns to 15 microns, from 1.5 microns to 10 microns, from 1.5 microns to 5 microns, from 1.5 microns to 2 microns, from 2 microns to 25 microns, from 2 microns to 20 microns, from 2 microns to 15 microns, from 2 microns to 10 microns, from 2 microns to 5 microns, from 2.5 microns to 25 microns, from 2.5 microns to 20 microns, from 2.5 microns to 15 microns, from 2.5 microns to 10 microns, or from 2.5 microns to 5 microns.

The basis weight of the second layer may vary widely. In one embodiment, the second layer has a basis weight from 4.5 g/m² to 50 g/m², e.g., 5 g/m² to 50 g/m², 10 g/m² to 50 g/m², from 10 g/m² to 48 g/m², from 10 g/m² to 46 g/m², from 10 g/m² to 44 g/m², from 10 g/m² to 42 g/m², 11 g/m² to 50 g/m², from 11 g/m² to 48 g/m², from 11 g/m² to 46 g/m², from 11 g/m² to 44 g/m², from 11 g/m² to 42 g/m², 12 g/m² to 50 g/m², from 12 g/m² to 48 g/m², from 12 g/m² to 46 g/m², from 12 g/m² to 44 g/m², from 12 g/m² to 42 g/m², 13 g/m² to 50 g/m², from 13 g/m² to 48 g/m², from 13 g/m² to 46 g/m², from 13 g/m² to 44 g/m², from 13 g/m² to 42 g/m², 14 g/m² to 50 g/m², from 14 g/m² to 48 g/m², from 14 g/m² to 46 g/m², from 14 g/m² to 44 g/m², from 14 g/m² to 42 g/m², or from 15 g/m² to 40 g/m².

In terms of lower limits, the basis weight of the second layer (e.g., polyamide) may be greater than 4.5 g/m², e.g., greater than 5 g/m², greater than 10 g/m², greater than 11 g/m², greater than 12 g/m², greater than 13 g/m², greater than 14 g/m², or greater than 15 g/m². In terms of upper limits, the basis weight of the second layer may be less than 50 g/m², e.g., less than 48 g/m², less than 46 g/m², less than 44 g/m², less than 42 g/m², or less than 40 g/m². In some cases, the basis weight of the second layer may be about 15 g/m², about 16 g/m², about 17 g/m², about 18 g/m², about 19 g/m², about 20 g/m², about 21 g/m², about 22 g/m², about 22 g/m², about 23 g/m², about 24 g/m², about 25 g/m², about 26 g/m², about 27 g/m², about 28 g/m², 29 g/m², about 30 g/m², about 31 g/m², about 32 g/m², about 33 g/m², about 34 g/m², about 35 g/m², about 36 g/m², about 37 g/m², about 38 g/m², about 39 g/m², about 40 g/m², about 41 g/m², about 42 g/m², about 43 g/m², about 44 g/m², or about 45 g/m².

In some embodiments, the basis weight of the second layer may be from 5 g/m² to 35 g/m², e.g., from 5 g/m² to 30 g/m², from 5 g/m² to 25 g/m², 6 g/m² to 35 g/m², from 6 g/m² to 30 g/m², from 6 g/m² to 25 g/m², 7 g/m² to 35 g/m², from 7 g/m² to 30 g/m², from 7 g/m² to 25 g/m², 8 g/m² to 35 g/m², from 8 g/m² to 30 g/m², from 8 g/m² to 25 g/m², 9 g/m² to 35 g/m², from 9 g/m² to 30 g/m², from 9 g/m² to 25 g/m², or from 10 g/m² to 20 g/m².

In some cases, the second layer (and/or the first layer) comprises two or more sub-layers or plys. Each sub-layer may comprise a polymer as herein (e.g., the composition, fiber diameter, and basis weight described above). In some cases, the sub-layers comprise the same polyamide. In some cases, the sub-layers comprise different polyamide. In one embodiment, the second layer comprises multiple sublayers, for example, combinations of melt blown layers and/or spunbond layers.

As noted above, the second layer isolates, traps, and/or otherwise removes a particulates and biological components. In some cases, the second layer may also inhibit the activity of a biological components. For example, the second layer may demonstrate antimicrobial/antiviral properties, which may include reducing, killing, etc. In some embodiments, for example, the second layer limits, reduces, or inhibits infection of a microbe, e.g., a bacterium or bacteria. In some embodiments, the second layer isolates and/or traps the microbe and also limits, reduces, or inhibits growth and/or kills the microbe. As a result, the filter media structure as a whole may exhibit antimicrobial properties and limit, reduce, or inhibit passage there through of biological components.

The pathogenic activity inhibited by the second layer may be that of a virus. Said another way, the second layer may demonstrate antiviral properties, which may include any antiviral effect. In some embodiments, for example, the second layer limits, reduces, or inhibits infection and/or pathogenesis of a virus. In some embodiments, the second layer isolates and/or traps the virus and also limits, reduces, or inhibits infection and/or pathogenesis of the virus. As a result, the filter media structure as a whole may exhibit antiviral properties and limit, reduce, or inhibit further viral infection. The other layers may have similar AM/AV properties.

In some cases, the second layer has little or no electric charge. In some cases, the antimicrobial and/or antiviral activity of the second layer is the result of an electrostatic charge of the fibers. For example, the plurality of fibers may have electric charge (e.g., a positive electric charge and/or a negative electric charge) and/or dipole polarization (e.g., one or more of the fibers may be an electret).

In some cases, the antimicrobial and/or antiviral activity of the second layer is the result of the composition of the fibers. For example, the plurality of fibers of the second layer may be composed of the antimicrobial and/or antiviral polymeric compositions described herein.

As noted above, the second layer is designed to filter a stream (air and/or liquid) that passes there through. In particular, the plurality of fibers of the second layer (as well as the first layer and/or the third layer) may demonstrate antimicrobial and/or antiviral activity. The use of a hydrophilic and/or hygroscopic polymer may increase or support the antimicrobial and/or antiviral properties of the second layer (or the other layers). It is theorized that a polymer of increased hydrophilicity and/or hygroscopy both may better attract liquid media that carry microbials and/or viruses, e.g., saliva or mucous, and may also absorb more moisture (e.g., from the air or breath) and that the increased moisture content allows the polymer composition and the antimicrobial/antiviral agent to more readily limit, reduce, or inhibit infection and/or pathogenesis of a microbe or virus. For example, the moisture may dissolve an outer layer (e.g., capsid) of a virus, exposing the genetic material (e.g., DNA or RNA) of the virus.

It is therefore desirable that the second layer be composed of a relatively hydrophilic and/or hygroscopic material. A polymer of increased hydrophilicity and/or hygroscopy may better attract and hold moisture to which to the filter media structure is exposed. As discussed below, improved (e.g., increased) hydrophilicity and/or hygroscopy may be accomplished by utilizing the polymer compositions described herein. Thus, it is particularly beneficial to form the second layer from a disclosed polymer composition.

In some cases, the second layer is a polymer, e.g., polyamide, having biological-reducing properties. Although the one of the layer of the filter media structure has biological-reducing properties, it is preferred that at least the second layer has biological-reducing properties. The first, and any optional layer, may also have biological-reducing properties. In some embodiments, by having at least one layer with biological-reducing properties, the entire filter media structure demonstrates AM/AV properties.

### Antimicrobial Activity; Antiviral Activity

In some embodiments, the AM/AV activity may be the result of the polymer composition from which the filter media structure or the layers thereof or the fibers thereof are formed. For example, the AM/AV activity may be the result of forming the filter media structure from a polymer composition described herein.

In some embodiments, the filter media structures exhibit robust, durable and/or long-lasting biological-reducing properties (AM/AV properties). This allows the filter media to have excellent wear characteristics. Such favorable capability provide the filter media structure to maintain the AM/AV properties of the polymer composition that last for a prolonged period of time, e.g., longer than one or more day, longer than one or more week, longer than one or more month, or longer than one or more years. This allows for storage of the filter media structure prior to use as well as prolonged use employed as a filter. In addition, the filter media may be reused because the biological-reducing properties do not wash out.

The AM/AV properties may include any antimicrobial effect. In some embodiments, for example, the antimicrobial properties of the filter media structure include limiting, reducing, or inhibiting infection of a microbe, e.g., a bacterium or bacteria. In some embodiments, the antimicrobial properties of the filter media structure include limiting, reducing, or inhibiting growth and/or killing a bacterium. In some cases, the filter media structure may limit, reduce, or inhibit both infection and growth of a bacterium.

The bacterium or bacteria affected by the antimicrobial properties of the filter media structure are not particularly limited. In some embodiments, for example, the bacterium is a Streptococcus bacterium (e.g., Streptococcus pneumonia, Streptococcus pyogenes), a Staphylococcus bacterium (e.g., Staphylococcus aureus, Methicillin-resistant Staphylococcus aureus (MRSA)), a Peptostreptococcus bacteria (e.g., Peptostreptococcus anaerobius, Peptostreptococcus asaccharolyticus), or a Mycobacterium bacterium, (e.g., Mycobacterium tuberculosis), a Mycoplasma bacteria (e.g., Mycoplasma adleri, Mycoplasma agalactiae, Mycoplasma agassizii, Mycoplasma amphoriforme, Mycoplasma fermentans, Mycoplasma genitalium, Mycoplasma haemofelis, Mycoplasma hominis, Mycoplasma hyopneumoniae, Mycoplasma hyorhinis, Mycoplasma pneumoniae). In some embodiments, the antimicrobial properties include limiting, reducing, or inhibiting the infection or pathogenesis of multiple bacteria, e.g., a combination of two or more bacteria from the above list.

The antimicrobial activity of the filter media structure may be measured by the standard procedure defined by ISO 20743:2013. This procedure measures antimicrobial activity by determining the percentage of a given bacterium or bacteria, e.g. Staphylococcus aureus, inhibited by a tested fiber. In one embodiment, the filter media structure inhibits the growth (growth reduction) of S. aureus in an amount ranging from 60% to 100%, e.g., from 60% to 99.999999%, from 60% to 99.99999%, from 60% to 99.9999%, from 60% to 99.999% from 60% to 99.999%, from 60% to 99.99%, from 60% to 99.9%, from 60% to 99%, from 60% to 98%, from 60% to 95%, from 65% to 99.999999%, from 65% to 99.99999%, from 65% to 99.9999%, from 65% to 99.999% from 65% to 99.999%, from 65% to 100%, from 65% to 99.99%, from 65% to 99.9%, from 65% to 99%, from 65% to 98%, from 65% to 95%, from 70% to 100%, from 70% to 99.999999%, from 70% to 99.99999%, from 70% to 99.9999%, from 70% to 99.999% from 70% to 99.999%, from 70% to 99.99%, from 70% to 99.9%, from 70% to 99%, from 70% to 98%, from 70% to 95%, from 75% to 100%, from 75% to 99.99%, from 75% to 99.9%, from 75% to 99.999999%, from 75% to 99.99999%, from 75% to 99.9999%, from 75% to 99.999% from 75% to 99.999%, from 75% to 99%, from 75% to 98%, from 75% to 95%, %, from 80% to 99.999999%, from 80% to 99.99999%, from 80% to 99.9999%, from 80% to 99.999% from 80% to 99.999%, from 80% to 100%, from 80% to 99.99%, from 80% to 99.9%, from 80% to 99%, from 80% to 98%, or from 80% to 95%. In terms of lower limits, the filter media structure may inhibit greater than 60% growth of S. aureus, e.g., greater than 65%, greater than 70%, greater than 75%, greater than 80%, greater than 85%, greater than 90%, greater than 95%, greater than 98%, greater than 99%, greater than 99.9%, greater than 99.99%, greater than 99.999%, greater than 99.9999%, greater than 99.99999%, or greater than 99.999999%.

The antimicrobial activity of the filter media structure may also be measured by determining the percentage of another bacterium or bacteria, e.g. Klebsiella pneumoniae, inhibited. In one embodiment, the filter media structure inhibits the growth (growth reduction) of K. pneumoniae in an amount ranging from 60% to 100%, e.g., from 60% to 99.999999%, from 60% to 99.99999%, from 60% to 99.9999%, from 60% to 99.999% from 60% to 99.999%, from 60% to 99.99%, from 60% to 99.9%, from 60% to 99%, from 60% to 98%, from 60% to 95%, from 65% to 100%, from 65% to 99.999999%, from 65% to 99.99999%, from 65% to 99.9999%, from 65% to 99.999% from 65% to 99.999%, from 65% to 99.99%, from 65% to 99.9%, from 65% to 99%, from 65% to 98%, from 65% to 95%, from 70% to 100%, from 70% to 99.999999%, from 70% to 99.99999%, from 70% to 99.9999%, from 70% to 99.999% from 70% to 99.999%, from 70% to 99.99%, from 70% to 99.9%, from 70% to 99%, from 70% to 98%, from 70% to 95%, from 75% to 100%, from 75% to 99.999999%, from 75% to 99.99999%, from 75% to 99.9999%, from 75% to 99.999% from 75% to 99.999%, from 75% to 99.99%, from 75% to 99.9%, from 75% to 99%, from 75% to 98%, from 75% to 95%, %, from 80% to 100%, from 80% to 99.999999%, from 80% to 99.99999%, from 80% to 99.9999%, from 80% to 99.999% from 80% to 99.999%, from 80% to 99.99%, from 80% to 99.9%, from 80% to 99%, from 80% to 98%, or from 80% to 95%. In terms of upper limits, the filter media structure may inhibit less than 100% growth of K. pneumoniae, e.g., less than 99.99%, less than 99.9%, less than 99%, less than 98%, or less than 95%. In terms of lower limits, the filter media structure may inhibit greater than 60% growth of K. pneumoniae, e.g., greater than 65%, greater than 70%, greater than 75%, or greater than 80%, greater than 85%, greater than 90%, greater than 95%, greater than 99%, greater than 99.9%, greater than 99.99%, greater than 99.999%, greater than 99.9999%, greater than 99.99999%, or greater than 99.999999%.

The AM/AV properties may include any antiviral effect. In some embodiments, for example, the antiviral properties of the filter media structure include limiting, reducing, or inhibiting infection of a virus. In some embodiments, the antiviral properties of the filter media structure include limiting, reducing, or inhibiting pathogenesis of a virus. In some cases, the polymer composition may limit, reduce, or inhibit both infection and pathogenesis of a virus.

The virus affected by the antiviral properties of the filter media structure is not particularly limited. In some embodiments, for example, the virus is an adenovirus, a herpesvirus, an ebolavirus, a poxvirus, a rhinovirus, a coxsackievirus, an arterivirus, an enterovirus, a morbillivirus, a coronavirus, an influenza A virus, an avian influenza virus, a swine-origin influenza virus, or an equine influence virus. In some embodiments, the antiviral properties include limiting, reducing, or inhibiting the infection or pathogenesis of one of virus, e.g., a virus from the above list. In some embodiments, the antiviral properties include limiting, reducing, or inhibiting the infection or pathogenesis of multiple viruses, e.g., a combination of two or more viruses from the above list.

In some cases, the virus is a coronavirus, e.g., severe acute respiratory syndrome coronavirus (SARS-CoV), Middle East respiratory syndrome coronavirus (MERS-CoV), or severe acute respiratory syndrome coronavirus 2 (SARS-CoV-2) (e.g., the coronavirus that causes COVID-19). In some cases, the virus is structurally related to a coronavirus.

In some cases, the virus is an influenza virus, such as an influenza A virus, an influenza B virus, an influenza C virus, or an influenza D virus, or a structurally related virus. In some cases, the virus is identified by an influenza A virus subtype, e.g., H1N1, H1N2, H2N2, H2N3, H3N1, H3N2, H3N8, H5N1, H5N2, H5N3, H5N6, H5N8, H5N9, H6N1, H7N1, H7N4, H7N7, H7N9, H9N2, or H10N7.

In some cases, the virus is a the virus is a bacteriophage, such as a linear or circular single-stranded DNA virus (e.g., phi X 174 (sometimes referred to as ΦX174)), a linear or circular double-stranded DNA, a linear or circular single-stranded RNA, or a linear or circular double-stranded RNA. In some cases, the antiviral properties of the polymer composition may be measured by testing using a bacteriophage, e.g., phi X 174.

In some cases, the virus is an ebolavirus, e.g., Bundibugyo ebolavirus (BDBV), Reston ebolavirus (RESTV), Sudan ebolavirus (SUDV), Tai Forest ebolavirus (TAFV), or Zaire ebolavirus (EBOV). In some cases, the virus is structurally related to an ebolavirus.

The antiviral activity may be measured by a variety of conventional methods. For example, AATCC TM100 may be utilized to assess the antiviral activity. In one embodiment, the filter media structure inhibits the pathogenesis (e.g., growth) of a virus in an amount ranging from 60% to 100%, e.g., from 60% to 99.999999%, from 60% to 99.99999%, from 60% to 99.9999%, from 60% to 99.999% from 60% to 99.999%, from 60% to 99.99%, from 60% to 99.9%, from 60% to 99%, from 60% to 98%, from 60% to 95%, from 65% to 99.999999%, from 65% to 99.99999%, from 65% to 99.9999%, from 65% to 99.999% from 65% to 99.999%, from 65% to 100%, from 65% to 99.99%, from 65% to 99.9%, from 65% to 99%, from 65% to 98%, from 65% to 95%, from 70% to 100%, from 70% to 99.999999%, from 70% to 99.99999%, from 70% to 99.9999%, from 70% to 99.999% from 70% to 99.999%, from 70% to 99.99%, from 70% to 99.9%, from 70% to 99%, from 70% to 98%, from 70% to 95%, from 75% to 100%, from 75% to 99.99%, from 75% to 99.9%, from 75% to 99.999999%, from 75% to 99.99999%, from 75% to 99.9999%, from 75% to 99.999% from 75% to 99.999%, from 75% to 99%, from 75% to 98%, from 75% to 95%, %, from 80% to 99.999999%, from 80% to 99.99999%, from 80% to 99.9999%, from 80% to 99.999% from 80% to 99.999%, from 80% to 100%, from 80% to 99.99%, from 80% to 99.9%, from 80% to 99%, from 80% to 98%, or from 80% to 95%. In terms of lower limits, a filter media structure may inhibit greater than 60% of pathogenesis of the virus, e.g., greater than 65%, greater than 70%, greater than 75%, greater than 80%, greater than 85%, greater than 90%, greater than 95%, greater than 98%, greater than 99%, greater than 99.9%, greater than 99.99%, greater than 99.999%, greater than 99.9999%, greater than 99.99999%, or greater than 99.999999%.

Antimicrobial and/or Antiviral Polymer Composition

As noted above, the filter media structures of the present disclosure may comprise at least one layer beneficially exhibits biological-reducing properties (antimicrobial and/or antiviral properties). For example, the first layer, the second layer, and/or the third layer may be made from and/or may comprise an antimicrobial/antiviral polymer composition as described herein. For convenience in this disclosure, the second layer comprises at the biological-reducing properties and may be positioned upstream or downstream of the first layer.

At least layer of the filter media structure, preferably the second layer, demonstrates biological-reducing properties may comprise a polymer and one or more AM/AV compounds, e.g., metals (e.g., metallic compounds). The metallic compounds include copper, zinc, or silver. In some embodiments, at least one layer of the filter media structure, preferably the second layer, comprise polymer fibers (preferably polyamide fibers), zinc (provided to the composition via a zinc compound), and/or optionally phosphorus (provided to the composition via a phosphorus compound). In some embodiments, at least one layer of the filter media structure comprise a polymer, copper (provided to the composition via a copper compound), and optionally phosphorus (provided to the composition via a phosphorus compound). In some embodiments, the metallic compounds may be embedded in the second layer. In other embodiment, the metallic compounds may be applied to one surface of the second layer as part of a topically treatment. The metallic compounds may be sprayed, coated or otherwise deposited

As discussed below, the polymer compositions described herein demonstrate antiviral properties. Further, the disclosed compositions may be used in the preparation of a variety of products. For example, the polymer compositions described herein may be formed into high-contact products (e.g., products handled by users). The products formed from the polymer compositions similarly demonstrate antiviral properties. Thus, the disclosed compositions may be used in the preparation of a variety of antiviral products.

In one embodiment at least one layer of the filter media structure, preferably the second layer, comprises polymer fibers such as polyamide fibers, metallic compound and, optionally, a phosphorus compound. The polyamide fibers may be a nonwoven layer or a spunbond layer. In one embodiment, the second layer comprises polyamide fibers in an amount ranging from 50 wt. % to 100 wt. %, e.g., from 50 wt. % to 99.99 wt. %, from 50 wt. % to 99.9 wt. %, from 50 wt. % to 99 wt. % from 55 wt. % to 100 wt. %, from 55 wt. % to 99.99 wt. %, from 55 wt. % to 99.9 wt. %, from 55 wt. % to 99 wt. %, from 60 wt. % to 100 wt. %, from 60 wt. % to 99.99 wt. %, from 60 wt. % to 99.9 wt. %, from 60 wt. % to 99 wt. %, from 65 wt. % to 100 wt. %, from 65 wt. % to 99.99 wt. %, from 65 wt. % to 99.9 wt. %, or from 65 wt. % to 99 wt. %. In terms of upper limits, the second layer may comprise less than 100 wt. % of the polyamide fibers, e.g., less than 99.99 wt. %, less than 99.9 wt. %, or less than 99 wt. %. In terms of lower limits, the second layer may comprise greater than 50 wt. % of the polyamide fibers, e.g., greater than 55 wt. %, greater than 60 wt. %, or greater than 65 wt. %.

### Metallic Compounds

As noted above, the at least one layer of the filter media structure may include one or more AM/AV compounds, which may be in the form of a metallic compound. For purposes of this discussion, the second layer will be described as having the one or more AM/AV compounds, but it should be understood that any other layer of the filter media structure may also have the one or more AM/AV compounds. In some embodiments, the second layer comprises zinc (e.g., in a zinc compound), phosphorus (e.g., in a zinc compound), copper (e.g., in a copper compound), silver (e.g., in a silver compound), or combinations thereof. As used herein, a metallic compound refers to a compound having at least one metal molecule or ion (e.g., a “zinc compound” refers to a compound having at least one zinc molecule or ion).

In some conventional polymer compositions, fiber layers utilize AM/AV compounds to inhibit viruses and other pathogens. For example, some fiber layers may include antimicrobial additives, e.g., silver, coated or applied as a film on an exterior surface. However, it has been found that these treatments or coatings often present a host of problems. For example, the coated additives may extract out of the fiber layers during dyeing or washing processes, which adversely affects the antimicrobial and/or antiviral properties. In contrast to conventional formulations, the polymer compositions disclosed herein comprise a unique combination of AM/AV compounds (e.g., metallic compounds) rather than simply coating the AM/AV compounds on a surface. This can provide the polymer composition with certain amounts of a metallic compound embedded in the polymer matrix such that the polymer composition retains AM/AV properties during and after dyeing and/or washing, and contributes to improved robustness and durability.

In one embodiment, AM/AV compounds can be added as a masterbatch. The masterbatch may include a polyamide such as nylon 6 or nylon 6,6. Other masterbatch compositions are contemplated.

The second layer may comprise metallic compounds, e.g., a metal or a metallic compound, dispersed within the polyamide composition. In one embodiment the metallic compound may be uniformly dispersed within the polyamide composition. In one embodiment, the polyamide composition comprises metallic compounds in an amount ranging from 1 wppm to 30,000 wppm, e.g., from 5 wppm to 20,000 wppm, from 5 wppm to 17,500 wppm, from 5 wppm to 17,000 wppm, from 5 wppm to 16,500 wppm, from 5 wppm to 16,000 wppm, from 5 wppm to 15,500 wppm, from 5 wppm to 15,000 wppm, from 5 wppm to 12,500 wppm, from 5 wppm to 10,000 wppm, from 5 wppm to 5000 wppm, from 5 wppm to 4000 wppm, e.g., from 5 wppm to 3000 wppm, from 5 wppm to 2000 wppm, from 5 wppm to 1000 wppm, from 5 wppm to 500 wppm, from 10 wppm to 20,000 wppm, from 10 wppm to 17,500 wppm, from 10 wppm to 17,000 wppm, from 10 wppm to 16,500 wppm, from 10 wppm to 16,000 wppm, from 10 wppm to 15,500 wppm, from 10 wppm to 15,000 wppm, from 10 wppm to 12,500 wppm, from 10 wppm to 10,000 wppm, from 10 wppm to 5000 wppm, from 10 wppm to 4000 wppm, from 10 wppm to 3000 wppm, from 10 wppm to 2000 wppm, from 10 wppm to 1000 wppm, from 10 wppm to 500 wppm, from 50 wppm to 20,000 wppm, from 50 wppm to 17,500 wppm, from 50 wppm to 17,000 wppm, from 50 wppm to 16,500 wppm, from 50 wppm to 16,000 wppm, from 50 wppm to 15,500 wppm, from 50 wppm to 15,000 wppm, from 50 wppm to 12,500 wppm, from 50 wppm to 10,000 wppm, from 50 wppm to 5000 wppm, from 50 wppm to 4000 wppm, from 50 wppm to 3000 wppm, from 50 wppm to 2000 wppm, from 50 wppm to 1000 wppm, from 50 wppm to 500 wppm, from 100 wppm to 20,000 wppm, from 100 wppm to 17,500 wppm, from 100 wppm to 17,000 wppm, from 100 wppm to 16,500 wppm, from 100 wppm to 16,000 wppm, from 100 wppm to 15,500 wppm, from 100 wppm to 15,000 wppm, from 100 wppm to 12,500 wppm, from 100 wppm to 10,000 wppm, from 100 wppm to 5000 wppm, from 100 wppm to 4000 wppm, from 100 wppm to 3000 wppm, from 100 wppm to 2000 wppm, from 100 wppm to 1000 wppm, from 100 wppm to 500 wppm, from 200 wppm to 20,000 wppm, from 200 wppm to 17,500 wppm, from 200 wppm to 17,000 wppm, from 200 wppm to 16,500 wppm, from 200 wppm to 16,000 wppm, from 200 wppm to 15,500 wppm, from 200 wppm to 15,000 wppm, from 200 wppm to 12,500 wppm, from 200 wppm to 10,000 wppm, from 200 wppm to 5000 wppm, from 200 wppm to 4000 wppm, from 200 wppm to 3000 wppm, from 200 wppm to 2000 wppm, from 200 wppm to 1000 wppm, or from 200 wppm to 500 wppm.

In terms of lower limits, the polyamide composition of the second layer may comprise greater than 5 wppm metallic compounds, e.g., greater than 10 wppm, greater than 50 wppm, greater than 100 wppm, greater than 200 wppm, or greater than 300 wppm. In terms of upper limits, the polymer composition may comprise less than 20,000 wppm metallic compounds, e.g., less than 17,500 wppm, less than 17,000 wppm, less than 16,500 wppm, less than 16,000 wppm, less than 15,500 wppm, less than 15,000 wppm, less than 12,500 wppm, less than 10,000 wppm, less than 5000 wppm, less than less than 4000 wppm, less than 3000 wppm, less than 2000 wppm, less than 1000 wppm, or less than 500 wppm. As noted above, the metallic compounds are preferably embedded in the polymer formed from the polymer composition.

The polyamide composition at least one layer of the filter media structure, preferably second layer, may comprise zinc (e.g., in a zinc compound), e.g., zinc or a zinc compound, dispersed therein, including uniformly dispersed. In one embodiment, the polyamide composition comprises zinc in an amount ranging from 1 wppm to 30,000 wppm, e.g., from 5 wppm to 20,000 wppm from 5 wppm to 17,500 wppm, from 5 wppm to 17,000 wppm, from 5 wppm to 16,500 wppm, from 5 wppm to 16,000 wppm, from 5 wppm to 15,500 wppm, from 5 wppm to 15,000 wppm, from 5 wppm to 12,500 wppm, from 5 wppm to 10,000 wppm, from 5 wppm to 5000 wppm, from 5 wppm to 4000 wppm, e.g., from 5 wppm to 3000 wppm, from 5 wppm to 2000 wppm, from 5 wppm to 1000 wppm, from 5 wppm to 500 wppm, from 10 wppm to 20,000 wppm, from 10 wppm to 17,500 wppm, from 10 wppm to 17,000 wppm, from 10 wppm to 16,500 wppm, from 10 wppm to 16,000 wppm, from 10 wppm to 15,500 wppm, from 10 wppm to 15,000 wppm, from 10 wppm to 12,500 wppm, from 10 wppm to 10,000 wppm, from 10 wppm to 5000 wppm, from 10 wppm to 4000 wppm, from 10 wppm to 3000 wppm, from 10 wppm to 2000 wppm, from 10 wppm to 1000 wppm, from 10 wppm to 500 wppm, from 50 wppm to 20,000 wppm, from 50 wppm to 17,500 wppm, from 50 wppm to 17,000 wppm, from 50 wppm to 16,500 wppm, from 50 wppm to 16,000 wppm, from 50 wppm to 15,500 wppm, from 50 wppm to 15,000 wppm, from 50 wppm to 12,500 wppm, from 50 wppm to 10,000 wppm, from 50 wppm to 5000 wppm, from 50 wppm to 4000 wppm, from 50 wppm to 3000 wppm, from 50 wppm to 2000 wppm, from 50 wppm to 1000 wppm, from 50 wppm to 500 wppm, from 100 wppm to 20,000 wppm, from 100 wppm to 17,500 wppm, from 100 wppm to 17,000 wppm, from 100 wppm to 16,500 wppm, from 100 wppm to 16,000 wppm, from 100 wppm to 15,500 wppm, from 100 wppm to 15,000 wppm, from 100 wppm to 12,500 wppm, from 100 wppm to 10,000 wppm, from 100 wppm to 5000 wppm, from 100 wppm to 4000 wppm, from 100 wppm to 3000 wppm, from 100 wppm to 2000 wppm, from 100 wppm to 1000 wppm, from 100 wppm to 500 wppm, from 200 wppm to 20,000 wppm, from 200 wppm to 17,500 wppm, from 200 wppm to 17,000 wppm, from 200 wppm to 16,500 wppm, from 200 wppm to 16,000 wppm, from 200 wppm to 15,500 wppm, from 200 wppm to 15,000 wppm, from 200 wppm to 12,500 wppm, from 200 wppm to 10,000 wppm, from 200 wppm to 5000 wppm, from 200 wppm to 4000 wppm, from 200 wppm to 3000 wppm, from 200 wppm to 2000 wppm, from 200 wppm to 1000 wppm, or from 200 wppm to 500 wppm.

In terms of lower limits, the polyamide composition may comprise greater than 5 wppm of zinc, e.g., greater than 10 wppm, greater than 50 wppm, greater than 100 wppm, greater than 200 wppm, or greater than 300 wppm. In terms of upper limits, the polymer composition may comprise less than 20,000 wppm of zinc, e.g., less than 17,500 wppm, less than 17,000 wppm, less than 16,500 wppm, less than 16,000 wppm, less than 15,500 wppm, less than 15,000 wppm, less than 12,500 wppm, less than 10,000 wppm, less than 5000 wppm, less than less than 4000 wppm, less than 3000 wppm, less than 2000 wppm, less than 1000 wppm, or less than 500 wppm. In some aspects, the zinc compound is embedded in the polymer formed from the polymer composition.

The amount of the zinc compound present in the polyamide compositions may be discussed in relation to the ionic zinc content. In one embodiment, the polyamide composition at least one layer of the filter media structure, preferably second layer, comprises ionic zinc, e.g., Zn²⁺, in an amount ranging from 1 ppm to 30,000 ppm by weight, e.g., from 1 ppm to 25,000 ppm, from 1 ppm to 20,000 ppm, from 1 ppm to 15,000 ppm, from 1 ppm to 10,000 ppm, from 1 ppm to 5,000 ppm, from 1 ppm to 2,500 ppm, from 50 ppm to 30,000 ppm, from 50 ppm to 25,000 ppm, from 50 ppm to 20,000 ppm, from 50 ppm to 15,000 ppm, from 50 ppm to 10,000 ppm, from 50 ppm to 5,000 ppm, from 50 ppm to 2,500 ppm, from 100 ppm to 30,000 ppm, from 100 ppm to 25,000 ppm, from 100 ppm to 20,000 ppm, from 100 ppm to 15,000 ppm, from 100 ppm to 10,000 ppm, from 100 ppm to 5,000 ppm, from 100 ppm to 2,500 ppm, from 150 ppm to 30,000 ppm, from 150 ppm to 25,000 ppm, from 150 ppm to 20,000 ppm, from 150 ppm to 15,000 ppm, from 150 ppm to 10,000 ppm, from 150 ppm to 5,000 ppm, from 150 ppm to 2,500 ppm, from 250 ppm to 30,000 ppm, from 250 ppm to 25,000 ppm, from 250 ppm to 20,000 ppm, from 250 ppm to 15,000 ppm, from 250 ppm to 10,000 ppm, from 250 ppm to 5,000 ppm, or from 250 ppm to 2,500 ppm. In some cases, the ranges and limits mentioned above for zinc may also be applicable to ionic zinc content.

The zinc of the polyamide composition is present in or provided via a zinc compound, which may vary widely. The zinc compound may comprise zinc oxide, zinc ammonium adipate, zinc acetate, zinc ammonium carbonate, zinc stearate, zinc phenyl phosphinic acid, or zinc pyrithione, or combinations thereof. In some embodiments, the zinc compound comprises zinc oxide, zinc ammonium adipate, zinc acetate, or zinc pyrithione, or combinations thereof. In some embodiments, the zinc compound comprises zinc oxide, zinc stearate, or zinc ammonium adipate, or combinations thereof. In some aspects, the zinc is provided in the form of zinc oxide. In some aspects, the zinc is not provided via zinc phenyl phosphinate and/or zinc phenyl phosphonate. In some aspects, the zinc is provided by dissolving one or more zinc compounds in ammonium adipate.

The inventors have also found that the polyamide composition at least one layer of the filter media structure, preferably second layer, surprisingly may benefit from the use of specific zinc compounds. In particular, the use of zinc compounds prone to forming ionic zinc (e.g., Zn²⁺) may increase the antiviral properties of the second layer and overall filter media structure. It is theorized that the ionic zinc disrupts the replicative cycle of the virus. For example, the ionic zinc may interfere with (e.g., inhibit) viral protease or polymerase activity. Further discussion of the effect of ionic zinc on viral activity is found in Velthuis et al., Zn Inhibits Coronavirus and Arterivirus RNA Polymerase Activity In Vitro and Zinc Ionophores Block the Replication of These Viruses in Cell Culture, PLoS Pathogens (November 2010), which is incorporated herein by reference. In addition, zinc ions embedded in the second layer may target the polar end groups and/or block the glycoprotein channels of virus. This causes the rupturing of the protective virus wall and renders the virus ineffective. Further, zinc ions zinc ions embedded in the second layer may disrupt and/or block the cellular pathways of bacteria leading reduce the bacterical growth.

The polyamide composition at least one layer of the filter media structure, preferably second layer, may comprise copper (e.g., in a copper compound), e.g., copper or a copper compound, dispersed within the polymer composition. In one embodiment, the polyamide composition comprises copper in an amount ranging from 5 wppm to 20,000 wppm, e.g., from 5 wppm to 17,500 wppm, from 5 wppm to 17,000 wppm, from 5 wppm to 16,500 wppm, from 5 wppm to 16,000 wppm, from 5 wppm to 15,500 wppm, from 5 wppm to 15,000 wppm, from 5 wppm to 12,500 wppm, from 5 wppm to 10,000 wppm, from 5 wppm to 5000 wppm, from 5 wppm to 4000 wppm, e.g., from 5 wppm to 3000 wppm, from 5 wppm to 2000 wppm, from 5 wppm to 1000 wppm, from 5 wppm to 500 wppm, from 10 wppm to 20,000 wppm, from 10 wppm to 17,500 wppm, from 10 wppm to 17,000 wppm, from 10 wppm to 16,500 wppm, from 10 wppm to 16,000 wppm, from 10 wppm to 15,500 wppm, from 10 wppm to 15,000 wppm, from 10 wppm to 12,500 wppm, from 10 wppm to 10,000 wppm, from 10 wppm to 5000 wppm, from 10 wppm to 4000 wppm, from 10 wppm to 3000 wppm, from 10 wppm to 2000 wppm, from 10 wppm to 1000 wppm, from 10 wppm to 500 wppm, from 50 wppm to 20,000 wppm, from 50 wppm to 17,500 wppm, from 50 wppm to 17,000 wppm, from 50 wppm to 16,500 wppm, from 50 wppm to 16,000 wppm, from 50 wppm to 15,500 wppm, from 50 wppm to 15,000 wppm, from 50 wppm to 12,500 wppm, from 50 wppm to 10,000 wppm, from 50 wppm to 5000 wppm, from 50 wppm to 4000 wppm, from 50 wppm to 3000 wppm, from 50 wppm to 2000 wppm, from 50 wppm to 1000 wppm, from 50 wppm to 500 wppm, from 100 wppm to 20,000 wppm, from 100 wppm to 17,500 wppm, from 100 wppm to 17,000 wppm, from 100 wppm to 16,500 wppm, from 100 wppm to 16,000 wppm, from 100 wppm to 15,500 wppm, from 100 wppm to 15,000 wppm, from 100 wppm to 12,500 wppm, from 100 wppm to 10,000 wppm, from 100 wppm to 5000 wppm, from 100 wppm to 4000 wppm, from 100 wppm to 3000 wppm, from 100 wppm to 2000 wppm, from 100 wppm to 1000 wppm, from 100 wppm to 500 wppm, from 200 wppm to 20,000 wppm, from 200 wppm to 17,500 wppm, from 200 wppm to 17,000 wppm, from 200 wppm to 16,500 wppm, from 200 wppm to 16,000 wppm, from 200 wppm to 15,500 wppm, from 200 wppm to 15,000 wppm, from 200 wppm to 12,500 wppm, from 200 wppm to 10,000 wppm, from 200 wppm to 5000 wppm, from 200 wppm to 4000 wppm, from 200 wppm to 3000 wppm, from 200 wppm to 2000 wppm, from 200 wppm to 1000 wppm, or from 200 wppm to 500 wppm.

In terms of lower limits, the polyamide composition may comprise greater than 5 wppm of copper, e.g., greater than 10 wppm, greater than 50 wppm, greater than 100 wppm, greater than 200 wppm, or greater than 300 wppm. In terms of upper limits, the polymer composition may comprise less than 20,000 wppm of copper, e.g., less than 17,500 wppm, less than 17,000 wppm, less than 16,500 wppm, less than 16,000 wppm, less than 15,500 wppm, less than 15,000 wppm, less than 12,500 wppm, less than 10,000 wppm, less than 5000 wppm, less than less than 4000 wppm, less than 3000 wppm, less than 2000 wppm, less than 1000 wppm, or less than 500 wppm. In some aspects, the copper compound is embedded in the polymer formed from the polymer composition.

The type of the copper compound is not particularly limited. Suitable copper compounds include copper iodide, copper bromide, copper chloride, copper fluoride, copper oxide, copper stearate, copper ammonium adipate, copper acetate, or copper pyrithione, or combinations thereof. The copper compound may comprise copper oxide, copper ammonium adipate, copper acetate, copper ammonium carbonate, copper stearate, copper phenyl phosphinic acid, or copper pyrithione, or combinations thereof. In some embodiments, the copper compound comprises copper oxide, copper ammonium adipate, copper acetate, or copper pyrithione, or combinations thereof. In some embodiments, the copper compound comprises copper oxide, copper stearate, or copper ammonium adipate, or combinations thereof. In some aspects, the copper is provided in the form of copper oxide. In some aspects, the copper is not provided via copper phenyl phosphinate and/or copper phenyl phosphonate. In some aspects, the copper is provided by dissolving one or more copper compounds in ammonium adipate.

The polyamide composition at least one layer of the filter media structure, preferably second layer, may comprise silver (e.g., in a silver compound), e.g., silver or a silver compound, dispersed within the polymer composition. In one embodiment, the polymer composition comprises silver in an amount ranging from 5 wppm to 20,000 wppm, e.g., from 5 wppm to 17,500 wppm, from 5 wppm to 17,000 wppm, from 5 wppm to 16,500 wppm, from 5 wppm to 16,000 wppm, from 5 wppm to 15,500 wppm, from 5 wppm to 15,000 wppm, from 5 wppm to 12,500 wppm, from 5 wppm to 10,000 wppm, from 5 wppm to 5000 wppm, from 5 wppm to 4000 wppm, e.g., from 5 wppm to 3000 wppm, from 5 wppm to 2000 wppm, from 5 wppm to 1000 wppm, from 5 wppm to 500 wppm, from 10 wppm to 20,000 wppm, from 10 wppm to 17,500 wppm, from 10 wppm to 17,000 wppm, from 10 wppm to 16,500 wppm, from 10 wppm to 16,000 wppm, from 10 wppm to 15,500 wppm, from 10 wppm to 15,000 wppm, from 10 wppm to 12,500 wppm, from 10 wppm to 10,000 wppm, from 10 wppm to 5000 wppm, from 10 wppm to 4000 wppm, from 10 wppm to 3000 wppm, from 10 wppm to 2000 wppm, from 10 wppm to 1000 wppm, from 10 wppm to 500 wppm, from 50 wppm to 20,000 wppm, from 50 wppm to 17,500 wppm, from 50 wppm to 17,000 wppm, from 50 wppm to 16,500 wppm, from 50 wppm to 16,000 wppm, from 50 wppm to 15,500 wppm, from 50 wppm to 15,000 wppm, from 50 wppm to 12,500 wppm, from 50 wppm to 10,000 wppm, from 50 wppm to 5000 wppm, from 50 wppm to 4000 wppm, from 50 wppm to 3000 wppm, from 50 wppm to 2000 wppm, from 50 wppm to 1000 wppm, from 50 wppm to 500 wppm, from 100 wppm to 20,000 wppm, from 100 wppm to 17,500 wppm, from 100 wppm to 17,000 wppm, from 100 wppm to 16,500 wppm, from 100 wppm to 16,000 wppm, from 100 wppm to 15,500 wppm, from 100 wppm to 15,000 wppm, from 100 wppm to 12,500 wppm, from 100 wppm to 10,000 wppm, from 100 wppm to 5000 wppm, from 100 wppm to 4000 wppm, from 100 wppm to 3000 wppm, from 100 wppm to 2000 wppm, from 100 wppm to 1000 wppm, from 100 wppm to 500 wppm, from 200 wppm to 20,000 wppm, from 200 wppm to 17,500 wppm, from 200 wppm to 17,000 wppm, from 200 wppm to 16,500 wppm, from 200 wppm to 16,000 wppm, from 200 wppm to 15,500 wppm, from 200 wppm to 15,000 wppm, from 200 wppm to 12,500 wppm, from 200 wppm to 10,000 wppm, from 200 wppm to 5000 wppm, from 200 wppm to 4000 wppm, from 200 wppm to 3000 wppm, from 200 wppm to 2000 wppm, from 200 wppm to 1000 wppm, or from 200 wppm to 500 wppm.

In terms of lower limits, the polyamide composition may comprise greater than 5 wppm of silver, e.g., greater than 10 wppm, greater than 50 wppm, greater than 100 wppm, greater than 200 wppm, or greater than 300 wppm. In terms of upper limits, the polyamide composition may comprise less than 20,000 wppm of silver, e.g., less than 17,500 wppm, less than 17,000 wppm, less than 16,500 wppm, less than 16,000 wppm, less than 15,500 wppm, less than 15,000 wppm, less than 12,500 wppm, less than 10,000 wppm, less than 5000 wppm, less than less than 4000 wppm, less than 3000 wppm, less than 2000 wppm, less than 1000 wppm, or less than 500 wppm. In some aspects, the silver compound is embedded in the polymer formed from the polymer composition.

The type of the silver compound is not particularly limited. Suitable silver compounds include silver iodide, silver bromide, silver chloride, silver fluoride, silver oxide, silver stearate, silver ammonium adipate, silver acetate, or silver pyrithione, or combinations thereof. The silver compound may comprise silver oxide, silver ammonium adipate, silver acetate, silver ammonium carbonate, silver stearate, silver phenyl phosphinic acid, or silver pyrithione, or combinations thereof. In some embodiments, the silver compound comprises silver oxide, silver ammonium adipate, silver acetate, or silver pyrithione, or combinations thereof. In some embodiments, the silver compound comprises silver oxide, silver stearate, or silver ammonium adipate, or combinations thereof. In some aspects, the silver is provided in the form of silver oxide. In some aspects, the silver is not provided via silver phenyl phosphinate and/or silver phenyl phosphonate. In some aspects, the silver is provided by dissolving one or more silver compounds in ammonium adipate.

The polyamide composition at least one layer of the filter media structure, preferably second layer, may comprise phosphorus (in a phosphorus compound), e.g., phosphorus or a phosphorus compound is dispersed within the polymer composition. In one embodiment, the polyamide composition comprises phosphorus in an amount of less than or equal to 1 wt. %. Various ranges of phosphorous compounds are within the present disclosure and may be in an amount ranging from 50 wppm to 10,000 wppm, e.g., from 50 wppm to 5000 wppm, from 50 wppm to 2500 wppm, from 50 wppm to 2000 wppm, from 50 wppm to 800 wppm, 100 wppm to 750 wppm, 100 wppm to 1800 wppm, from 100 wppm to 10,000 wppm, from 100 wppm to 5000 wppm, from 100 wppm to 2500 wppm, from 100 wppm to 1000 wppm, from 100 wppm to 800 wppm, from 200 wppm to 10,000 wppm, 200 wppm to 5000 wppm, from 200 wppm to 2500 wppm, from 200 wppm to 800 wppm, from 300 wppm to 10,000 wppm, from 300 wppm to 5000 wppm, from 300 wppm to 2500 wppm, from 300 wppm to 500 wppm, from 500 wppm to 10,000 wppm, from 500 wppm to 5000 wppm, or from 500 wppm to 2500 wppm. In terms of lower limits, the polymer composition may comprise greater than 50 wppm of phosphorus, e.g., greater than 75 wppm, greater than 100 wppm, greater than 150 wppm, greater than 200 wppm greater than 300 wppm or greater than 500 wppm. In terms of upper limits, the polymer composition may comprise less than 10000 wppm (or 1 wt. %), e.g., less than 5000 wppm, less than 2500 wppm, less than 2000 wppm, less than 1800 wppm, less than 1500 wppm, less than 1000 wppm, less than 800 wppm, less than 750 wppm, less than 500 wppm, less than 475 wppm, less than 450 wppm, or less than 400 wppm. In some aspects, the phosphorus or the phosphorus compound is embedded in the polymer formed from the polymer composition.

The phosphorus of the polyamide composition is present in or provided via a suitable phosphorus compound, which may vary widely. The phosphorus compound may comprise benzene phosphinic acid, diphenylphosphinic acid, sodium phenylphosphinate, phosphorous acid, benzene phosphonic acid, calcium phenylphosphinate, potassium B-pentylphosphinate, methylphosphinic acid, manganese hypophosphite, sodium hypophosphite, monosodium phosphate, hypophosphorous acid, dimethylphosphinic acid, ethylphosphinic acid, diethylphosphinic acid, magnesium ethylphosphinate, triphenyl phosphite, diphenylmethyl phosphite, dimethylphenyl phosphite, ethyldiphenyl phosphite, phenylphosphonic acid, methylphosphonic acid, ethylphosphonic acid, potassium phenylphosphonate, sodium methylphosphonate, calcium ethylphosphonate, and combinations thereof. In some embodiments, the phosphorus compound comprises phosphoric acid, benzene phosphinic acid, or benzene phosphonic acid, or combinations thereof. In some embodiments, the phosphorus compound comprises benzene phosphinic acid, phosphorous acid, or manganese hypophosphite, or combinations thereof. In some aspects, the phosphorus compound may comprise benzene phosphinic acid.

### Further Layers

The disclosed filter media structures may include one or more further layers. This may include a scrim, substrate, protective layer, or outer layer. These optional layers includes woven, knitted, or nonwoven layer. The further layers may also be a wire mesh. The structure of the further layer is not particularly limited. In some embodiments, the further layer is a woven, nonwoven, or knitted layers. It should be understood that each of the further layers may be different and there may be multiple types of further layers.

The composition of the further layers depends on filter media structure. In some embodiments, the further layer comprises the polymer composition which is discussed in detail below. Although it is preferred to include the AM/AV compound in the second layer, in some embodiments, the further layer may comprise an AM/AV compound, and in some cases, the AM/AV compound provided for the AM/AV benefits.

The thermoplastics for the further layers may include, but are not limited, to polyester, nylon, rayon, polyamide 6, polyamide 6,6, polyethylene (PE), polypropylene (PP), polyethylene terephthalate (PET), polyethylene terephthalate glycol (PETG), co-PET, polybutylene terephthalate (PBT) polylactic acid (PLA), and polytrimethylene terephthalate (PTT). For example, these further layers may comprises spunbond polyamide, electrospun polyamide, meltblown polyamide or flashspun polyamide. In some cases, the further layers comprises polyamide fibers, e.g., polyamide microfibers or polyamide nanofibers.

In one embodiment, the further layers include a scrim layer, e.g., a reinforcing layer which may be bounded to one surface of the second layer. In some aspects, the scrim layer is selected to have a sizeable filtration capacity and efficiency. In other aspects, however, the scrim layer may have little or no filtration capacity or efficiency. The scrim layer may have a thickness from 0.1 to 5 mm, e.g., from 0.1 to 2.5 mm, from 0.1 mm to 2 mm, from 0.1 mm to 1.5 mm, from 0.1 mm to 1 mm, or any subrange or values in between. In one embodiment a scrim having a thickness less than 0.25 mm is sufficient to provide adequate strength. The basis weight of the scrim may be from 5 to 250 gsm, e.g., 5 to 200 gsm, from 5 to 150 gsm, from 5 to 100 gsm from 5 to 60 gsm, from 15 to 45 gsm, or any values in between. When the scrim is constructed of a thermoplastic, the fibers of the scrim may have a median fiber diameter from 1 to 1000 micrometers, e.g., from 1 to 500 micrometers, from 1 to 100 micrometers, or any subrange or values in between. The thickness, basis weight, and median fiber diameter may be chosen based on the type of filter structure media in which the scrim is used. Generally, the scrim may have a Frazier air permeability at a differential pressure of 0.5 inch of water between 111 CFM and 1675 CFM, e.g., from 450 to 650 CFM, from 500 to 600 CFM, from 550 to 1675 or any values in between. Filtration efficiency of the scrim layer can be characterized by comparing the number of dust particulates with the particle size ranging from 0.3 μm to 10 μm on the upstream and downstream sides of the scrim measured using PALAS MFP-2000 (Germany) equipment. In one embodiment the filtration efficiency of a scrim selected for the scrim layer is measured using ISO Fine dust having 70 mg/m³ dust concentration, a sample testing size of 100² cm, and face velocity of 20 cm/s. A suitable scrim may be selected from generally commercially available scrims, or formed via spun bonding process or carding process or batting process or another process using a suitable polymer. A suitable polymer for the scrim includes but not limited to polyester, polypropylene, polyethylene and polyamide, e.g., a nylon or a combination of two or more of these polymers. For example, scrim suitable for the scrim layer is available in various thicknesses from suppliers including among others Berry Plastics formerly Fiberweb Inc, of Old Hickory, Tenn. or Cerex Advanced Fabrics, Inc. of Cantonment, Fla. More than one scrim layer may be incorporated into the filter media.

An additional layer in the filter media is the polyamide nanofiber layer. In some aspects, this layer is spun or melt blown directly onto the scrim layer or scrim layers. In some embodiments, the polyamide nanofiber layer has a thickness of at least 1 mm, typically between 1.0 mm and 6.0 mm, preferably between 0.07 mm and 3 mm, and in one embodiment about 0.13 mm; and a basis weight less than 150 g/m², e.g., a basis weight less than 120 g/m², or basis weight of less than 100 g/m². In terms of ranges, the basis weight may be from 5 to 150 g/m², e.g., from 10 to 150 g/m², from 10 to 120 g/m² or 10 to 100 g/m². The thickness of the scrim may range from 0.05 mm to 5 mm, e.g., from 0.05 mm to 2.5 mm, from 0.05 mm to 1 mm, from 0.5 mm to 1 mm, from 0.5 mm to 0.9 mm. The fibers of scrim layer may have a median fiber diameter of from 1 micron to 50 microns, e.g., from 5 microns to 30 microns, from 5 microns to 25 microns, from 10 microns to 20 microns.

In addition to the scrim the further layer can include conventional layers may also be included. In some aspects, additional layers may include polymers such as polyvinyl chloride (PVC), polyolefin, polyacetal, polyester, cellulous ether, polyalkylene sulfide, polyarylene oxide, polysulfone, modified polysulfone polymers and polyvinyl alcohol, polyamide, polystyrene, polyacrylonitrile, polyvinylidene chloride, polymethyl methacrylate, and polyvinylidene fluoride.

In other embodiment, the further layer may be another filter layer having a basis weight from 5 g/m² to 50 g/m², e.g., from 5 g/m² to 48 g/m², from 5 g/m² to 45 g/m², from 5 g/m² to 42 g/m², from 5 g/m² to 40 g/m², 8 g/m² to 50 g/m², from 8 g/m² to 48 g/m², from 8 g/m² to 45 g/m², from 8 g/m² to 42 g/m², from 8 g/m² to 40 g/m², 10 g/m² to 50 g/m², from 10 g/m² to 48 g/m², from 10 g/m² to 45 g/m², from 10 g/m² to 42 g/m², from 10 g/m² to 40 g/m², 12 g/m² to 50 g/m², from 12 g/m² to 48 g/m², from 12 g/m² to 45 g/m², from 12 g/m² to 42 g/m², from 12 g/m² to 40 g/m², 14 g/m² to 50 g/m², from 14 g/m² to 48 g/m², from 14 g/m² to 45 g/m², from 14 g/m² to 42 g/m², from 14 g/m² to 40 g/m², or from 15 g/m² to 38 g/m².

In terms of lower limits, the basis weight of the further layer used for filtration may be greater than 5 g/m², e.g., greater than 8 g/m², greater than 10 g/m², greater than 12 g/m², greater than 14 g/m², or greater than 15 g/m². In terms of upper limits, the basis weight of the further layer may be less than 50 g/m², e.g., less than 48 g/m², less than 45 g/m², less than 42 g/m², less than 40 g/m², or less than 38 g/m². In some cases, the basis weight of the further layer may be about 10 g/m², about 11 g/m², about 12 g/m², about 13 g/m², about 14 g/m², about 15 g/m², about 16 g/m², about 18 g/m², about 19 g/m², about 20 g/m², about 21 g/m², about 22 g/m², about 23 g/m², about 24 g/m², about 25 g/m², about 26 g/m², about 27 g/m², about 28 g/m², about 29 g/m², about 30 g/m², about 31 g/m², about 32 g/m², about 33 g/m², about 34 g/m², about 35 g/m², about 36 g/m², about 37 g/m², about 38 g/m², about 39 g/m², or about 40 g/m², or a basis weight there between.

In some embodiments, the further layer comprises a plurality of fibers having an average fiber diameter less than 50 microns, e.g., less than 45 microns, less than 40 microns, less than 35 microns, less than 30 microns, less than 25 microns, less than 20 microns, less than 15 microns, less than 10 microns, or less than 5 microns. In terms of lower limits, the plurality of fibers may have an average fiber diameter greater than 1 micron, e.g., greater than 1.5 microns, greater than 2 microns, greater than 2.5 microns, greater than 5 microns, or greater than 10 microns. In terms of ranges, the plurality of fibers may have an average fiber diameter from 1 micron to 50 microns, e.g., from 1 micron to 45 microns, from 1 micron to 40 microns, from 1 micron to 35 microns, from 1 micron to 30 microns, from 1 micron to 20 microns, from 1 micron to 15 microns, from 1 micron to 10 microns, from 1 micron to 5 microns, from 1.5 microns to 25 microns, from 1.5 microns to 20 microns, from 1.5 microns to 15 microns, from 1.5 microns to 10 microns, from 1.5 microns to 5 microns, from 2 microns to 25 microns, from 2 microns to 20 microns, from 2 microns to 15 microns, from 2 microns to 10 microns, from 2 microns to 5 microns, from 2.5 microns to 25 microns, from 2.5 microns to 20 microns, from 2.5 microns to 15 microns, from 2.5 microns to 10 microns, from 2.5 microns to 5 microns, from 5 microns to 45 microns, from 5 microns to 40 microns, from 5 microns to 35 microns, from 5 microns to 30 microns, from 10 microns to 45 microns, from 10 microns to 40 microns, from 10 microns to 35 microns, from 10 microns to 30 microns.

In some embodiments, the further layer comprises a plurality of fibers having an average fiber diameter less than 1 micron, e.g., less than 0.9 microns, less than 0.8 microns, less than 0.7 microns, less than 0.6 microns, less than 0.5 microns, less than 0.4 microns, less than 0.3 microns, less than 0.2 microns, less than 0.1 microns, less than 0.05 microns, less than 0.04 microns, or less than 0.3 microns. In terms of lower limits, the average fiber diameter of the plurality of fibers may be greater than 1 nanometer, e.g., greater than 10 nanometers, greater than 25 nanometers, or greater than 50 nanometers. In terms of ranges, the average fiber diameter of the plurality of fibers may be from 1 nanometer to 1 micron, e.g., from 1 nanometer to 0.9 microns, from 1 nanometer to 0.8 microns, from 1 nanometer to 0.7 microns, from 1 nanometer to 0.6 microns, from 1 nanometer to 0.5 microns, from 1 nanometer to 0.4 microns, from 1 nanometer to 0.3 microns, from 1 nanometer to 0.2 microns, from 1 nanometer to 0.1 microns, from 1 nanometer to 0.05 microns, from 1 nanometer to 0.04 microns, from 1 nanometer to 0.3 microns, from 10 nanometers to 1 micron, from 10 nanometers to 0.9 microns, from 10 nanometers to 0.8 microns, from 10 nanometers to 0.7 microns, from 10 nanometers to 0.6 microns, from 10 nanometers to 0.5 microns, from 10 nanometers to 0.4 microns, from 10 nanometers to 0.3 microns, from 10 nanometers to 0.2 microns, from 10 nanometers to 0.1 microns, from 10 nanometers to 0.05 microns, from 10 nanometers to 0.04 microns, from 10 nanometers to 0.3 microns, from 25 nanometers to 1 micron, from 25 nanometers to 0.9 microns, from 25 nanometers to 0.8 microns, from 25 nanometers to 0.7 microns, from 25 nanometers to 0.6 microns, from 25 nanometers to 0.5 microns, from 25 nanometers to 0.4 microns, from 25 nanometers to 0.3 microns, from 25 nanometers to 0.2 microns, from 25 nanometers to 0.1 microns, from 25 nanometers to 0.05 microns, from 25 nanometers to 0.04 microns, from 25 nanometers to 0.3 microns, from 50 nanometers to 1 micron, from 50 nanometers to 0.9 microns, from 50 nanometers to 0.8 microns, from 50 nanometers to 0.7 microns, from 50 nanometers to 0.6 microns, from 50 nanometers to 0.5 microns, from 50 nanometers to 0.4 microns, from 50 nanometers to 0.3 microns, from 50 nanometers to 0.2 microns, from 50 nanometers to 0.1 microns, from 50 nanometers to 0.05 microns, from 50 nanometers to 0.04 microns, or from 50 nanometers to 0.3 microns.

In some cases, the further layer is a polymer, e.g., polyamide, layer made from the polymer compositions described herein.

As noted above, the further layer may be designed to isolate the filtered area, which may require exposure to moisture. It is therefore desirable that the further layer be composed of a relatively hydrophilic and/or hygroscopic material. A polymer of increased hydrophilicity and/or hygroscopy may better attract and hold moisture to which to the filter media structure is exposed. As discussed below, improved (e.g., increased) hydrophilicity and/or hygroscopy may be accomplished by utilizing the polymer compositions described herein. Thus, it is particularly beneficial to form the third layer from a disclosed polymer composition.

In addition, because the further layer may be designed to isolate the filtered area, it is desirable that the third layer exhibit AM/AV properties. During use, the further layer may be the layer most exposed to the environment. Furthermore, the further layer may be exposed to microbes and/or viruses (e.g., on surfaces or other objects) before or after use. Thus, it is particularly beneficial to form the further layer from an AM/AV polymer compositions as described herein.

Some embodiments of the filter media structures described herein may include additional layers. In some cases, one or more additional layers are added to improve one or performance characteristics of the filter media structure (e.g., filtration efficiency). In some cases, one or more additional layers are added to improve suitability for a final use.

In some embodiments, the filter media structure comprises one or more additional filter layers adjacent to the second layer of the filter media structure. In some embodiments, the additional filter layer(s) is substantially contiguous with the second layer of the filter media structure. The composition of the additional filter layer is not particularly limited, and any composition and structure described above with respect to the second layer may be utilized.

In some cases, one or more of the layers comprises two or more sub-layers. Each sub-layer may comprise a thermoplastic as described with regard to the layers generally (e.g., the composition, fiber diameter, and basis weight described above). In some cases, the sub-layers comprise the same thermoplastic. In some cases, the sub-layers comprise different thermoplastic. In one embodiment, the second layer comprises multiple sublayers, for example, a combination of melt blown layers and/or spunbond layers.

In some cases, the second layer is a two-ply layer in that it comprises two layers (e.g., at least two layers). Each of the two layers may be structured and/or composed as described above. Each layer of the two-ply second layer may be structurally and/or compositionally identical, or the layers may structurally and/or compositionally differ.

Said another way, in some embodiments, the filter media structure comprises four layers: a first layer (e.g., a charged web), a second layer (e.g., a layer having a biological-reducing performance) and two third layers being a scrim and an outer layer. In some embodiments, each adjacent layer may be joined by a suitable binding adhesive.

In some embodiments, the filter media structure comprises an additional scrim layer. The scrim layer may be a woven, nonwoven, or knit fabric adjacent on an outer surface and/or inner surface of the filter media structure. The composition of the additional scrim layer is not particularly limited, and any composition and structure described above with respect to the first layer may be utilized. In some cases, the filter media structure may comprise an additional scrim layer on the surface of the first layer opposite the second layer (e.g., the first layer may be sandwiched between the scrim layer and the second layer). In some cases, the filter media structure may comprise an additional scrim layer on the surface of the third layer opposite the second layer (e.g., the third layer may be sandwiched between second layer and the scrim layer). In some cases, the filter media structure may comprise an additional scrim layer on both the surface of the first layer opposite the second layer and the surface of the third layer opposite the second layer.

In some cases, the filter media structure may comprise an indicator. The indicator may be used to indicate expiration, temperature exposure, and/or sterility. The indicator may change appearance, when a trigger condition takes place. The mechanism of the indicator may vary widely. Exemplary mechanisms include dye diffusion, color change, chemical reaction (CO₂ or redox), and/or electrochemical. In some embodiments, the indicator may be in the form of a sticker. In some embodiments, the indicator may be in the form of a token, a visual cue, an insignia. This listing is not all inclusive and other indicators are contemplated.

### Physical Characteristics

As noted, each layer of the filter media structure may benefit from increased hydrophilicity and/or hygroscopy. In particular, the use of a hydrophilic and/or hygroscopic polymer may facilitate the functioning of the filter media structure and may increase the antimicrobial and/or antiviral properties of the polymer composition. A polymer of increased hydrophilicity and/or hygroscopy both may better attract liquid media that carry microbials and/or viruses, e.g., saliva or mucous, and may also absorb more moisture (e.g., from the air or breath) and that the increased moisture content allows the polymer composition and the antimicrobial/antiviral agent to more readily limit, reduce, or inhibit infection and/or pathogenesis of a microbe or virus. For example, the moisture may dissolve an outer layer (e.g., capsid) of a virus, exposing the genetic material (e.g., DNA or RNA) of the virus. Thus, each of the first layer, second layer, and third layer may benefit from increased hydrophilicity and/or hygroscopy. In preferred embodiments, the first layer, the second layer, and/or the third layer demonstrates relatively high hydrophilicity and/or hygroscopy.

In some cases, the hydrophilicity and/or hygroscopy of a given layer of the filter media structure (e.g., of the first layer, the second layer, and/or the third layer) may be measured by saturation.

In some cases, the hydrophilicity and/or hygroscopy of a given layer of the filter media structure (e.g., of the first layer, the second layer, and/or the third layer) may be measured by the amount of water it can absorb (as a percentage of total weight). In some embodiments, the layer is capable of absorbing greater than 1.5 wt. % water, based on the total weight of the polymer, e.g., greater than 2.0 wt. %, greater than 3.0%, greater than 5.0 wt. %, or greater than 7.0 wt. %. In terms of ranges, the hydrophilic and/or hygroscopic polymer may be capable of absorbing water in an amount ranging from 1.5 wt. % to 10.0 wt. %, e.g., from 1.5 wt. % to 9.0 wt. %, from 2.0 wt. % to 8 wt. %, from 2.0 wt. % to 7 w %, of from 2.5 wt. % to 7 wt. %.

In some cases, the hydrophilicity and/or the hygroscopy of a given layer of the filter media structure (e.g., of the first layer, the second layer, and/or the third layer) may be measured by the water contact angle of the layer. The water contact angle is the angle formed by the interface of a surface of the layer (e.g., of the first layer, the second layer, or the third layer). Preferably, the contact angle of the layer is measured while the layer is flat (e.g., substantially flat).

In some embodiments, a layer of the filter media structure (e.g., the first layer, the second layer, and/or the third layer) demonstrates a water contact angle less than 90°, e.g., less than 85°, less than 80°, or less than 75°. In terms of lower limits, the water contact angle of a layer of the filter media structure may be greater than 10°, e.g., greater than 20°, greater than 30°, or greater than 40°. In terms of ranges, the water contact angle of a layer of the filter media structure may be from 10° to 90°, e.g., from 10° to 85°, from 10° to 80°, from 10° to 75°, from 20° to 90°, from 20° to 85°, from 20° to 80°, from 20° to 75°, from 30° to 90°, from 30° to 85°, from 30° to 80°, from 30° to 75°, from 40° to 90°, from 40° to 85°, from 40° to 80°, or from 40° to 75°.

As noted, the increased hydrophilicity and/or hygroscopy of filter media structure (e.g., of a given layer of the polymer structure) may be the result of a polymer composition from which the layer is formed. The polymer compositions described herein, for example, demonstrate increased hydrophilicity and/or hygroscopy and are therefore particularly suitable for the disclosed filter media structure.

In some embodiments, a polymer may be specially prepared to impart increased hydrophilicity and/or hygroscopy. For example, an increase in hygroscopy may be achieved in the selection and/or modification the polymer. In some embodiments, the polymer may be a common polymer, e.g., a common polyamide, which has been modified to increase hygroscopy. In these embodiments, a functional end group modification on the polymer may increase hygroscopy. For example, the polymer may be PA-6,6, which has been modified to include a functional end group that increases hygroscopy.

### Performance Characteristics

The performance of the filter media structures described herein may be assessed using a variety of conventional metrics. For example, the performance characteristics of the filter media structure may be described by reference to particulate filtration efficiency and/or bacterial filtration efficiency. As discussed above, these characteristics are often used in rating the effectiveness of a filter media structure, e.g., by NIOSH and ASTM International.

Particulate filtration efficiency (or “PFE”) measures how well a filter media structure traps or isolates sub-micron particles. Generally, PFE is considered relevant to the effectiveness of a filter media structure in trapping or isolating viruses. In particular, PFE measures a percentage of particles that are trapped or isolated by the filter media structure. ASTM International specifies that a particle size of 0.1 micron be used.

In some embodiments, the filter media structure demonstrates a PFE greater than 90%, e.g., greater than 92%, greater than 93%, greater than 94%, greater than 95%, greater than 97%, greater than 98%, greater than 99%, greater than 99.5%, greater than 99.9%, or greater than 99.99%. In terms upper limits, the filter media structure may demonstrate a PFE less than 100%, e.g., less than 99.999%, less than 99.995%, less than 99.99%, or less than 99.95%.

In some embodiments, the filter media structure demonstrates a PFE of about 90%, about 91%, about 92%, about 93%, about 94%, about 95%, about 95.5%, about 96%, about 96.5%, about 97%, about 97.5%, about 98%, about 98.5%, about 99%, about 99.2%, about 99.3%, about 99.4%, about 99.5%, about 99.8%, about 99.9%, about 99.95%, or about 99.99%, or any percentage there between.

Bacterial filtration efficiency (or “BFE”) measures how well the filter media structure traps or isolates bacteria when exposed to a bacteria-containing aerosol. As with PFE, BFE measures a percentage of bacteria that trapped or isolated by the filter media structure. ASTM International specifies testing with a droplet size of 3.0 microns containing Staph. aureus (average size 0.6-0.8 microns). To be used in a surgical or medical setting, a filter media structure typically must demonstrate a BFE of at least 95%.

In some embodiments, the filter media structure demonstrates a BFE greater than 90%, e.g., greater than 92%, greater than 93%, greater than 94%, greater than 95%, greater than 97%, greater than 98%, greater than 99%, greater than 99.5%, greater than 99.9%, or greater than 99.99%. In terms upper limits, the filter media structure may demonstrate a BFE less than 100%, e.g., less than 99.999%, less than 99.995%, less than 99.99%, or less than 99.95%.

In some embodiments, the filter media structure demonstrates a BFE of about 90%, about 91%, about 92%, about 93%, about 94%, about 95%, about 95.5%, about 96%, about 96.5%, about 97%, about 97.5%, about 98%, about 98.5%, about 99%, about 99.2%, about 99.3%, about 99.4%, about 99.5%, about 99.8%, about 99.9%, about 99.95%, or about 99.99%, or any percentage there between.

### Additional Components

In some embodiments, any of the layers of the filter media structure may comprise additional additives. The additives include pigments, hydrophilic or hydrophobic additives, anti-odor additives, additional antiviral agents, and antimicrobial/anti-fungal inorganic compounds, such as copper, zinc, tin, and silver.

In some embodiments, the polymer composition can be combined with color pigments for coloration. In some aspects, the polymer composition can be combined with UV additives to withstand fading and degradation in filters exposed to significant UV light. In some aspects, the polymer composition can be combined with additives to make the surface of the fiber hydrophilic or hydrophobic. In some aspects, the polymer composition can be combined with a hygroscopic material, e.g., to make the fiber, filter, or other products formed therefrom more hygroscopic. In some aspects, the polymer composition can be combined with additives to make the filter media structure thermally resistant, e.g., having flame retardant properties. In some aspects, the polymer composition can be combined with additives to make the filter stain resistant. In some aspects, the polymer composition can be combined with pigments with the antimicrobial compounds so that the need for conventional dyeing and disposal of dye materials is avoided.

In some embodiments, the polymer composition may further comprise additional additives. For example, the polymer composition may comprise a delusterant. A delusterant additive may improve the appearance and/or texture of the synthetic fibers and filter produced from the polymer composition. In some embodiments, inorganic pigment-like materials can be utilized as delusterants. The delusterants may comprise one or more of titanium dioxide, barium sulfate, barium titanate, zinc titanate, magnesium titanate, calcium titanate, zinc oxide, zinc sulfide, lithopone, zirconium dioxide, calcium sulfate, barium sulfate, aluminum oxide, thorium oxide, magnesium oxide, silicon dioxide, talc, mica, and the like. In preferred embodiments, the delusterant comprises titanium dioxide. It has been found that the polymer compositions that include delusterants comprising titanium dioxide produce synthetic fibers and filter that greatly resemble natural fibers, e.g., with improved aesthically appearance and/or texture. It is believed that titanium dioxide improves appearance and/or texture by interacting with the zinc compound, the optional phosphorus compound, and/or functional groups within the polymer.

In one embodiment, the polymer composition comprises the delusterant in an amount ranging from 0.0001 wt. % to 3 wt. %, e.g., 0.0001 wt. % to 2 wt. %, from 0.0001 to 1.75 wt. %, from 0.001 wt. % to 3 wt. %, from 0.001 wt. % to 2 wt. %, from 0.001 wt. % to 1.75 wt. %, from 0.002 wt. % to 3 wt. %, from 0.002 wt. % to 2 wt. %, from 0.002 wt. % to 1.75 wt. %, from 0.005 wt. % to 3 wt. %, from 0.005 wt. % to 2 wt. %, from 0.005 wt. % to 1.75 wt. %. In terms of upper limits, the polymer composition may comprise less than 3 wt. % delusterant, e.g., less than 2.5 wt. %, less than 2 wt. % or less than 1.75 wt. %. In terms of lower limits, the polymer composition may comprise greater than 0.0001 wt. % delusterant, e.g., greater than 0.001 wt. %, greater than 0.002 wt. %, or greater than 0.005 wt. %.

In some embodiments, the polymer composition may further comprises colored materials, such as carbon black, copper phthalocyanine pigment, lead chromate, iron oxide, chromium oxide, and ultramarine blue.

In some embodiments, the polymer composition may include additional antiviral agents other than zinc. The additional antimicrobial agents may be any suitable antiviral. Conventional antiviral agents are known in the art and may be incorporated in the polymer composition as the additional antiviral agent or agents. For example, the additional antiviral agent may be an entry inhibitor, a reverse transcriptase inhibitor, a DNA polymerase inhibitor, an m-RNA synthesis inhibitor, a protease inhibitor, an integrase inhibitor, or an immunomodulator, or combinations thereof. In some aspects, the additional antimicrobial agent or agents are added to the polymer composition.

In some embodiments, the polymer composition may include additional antimicrobial agents other than zinc. The additional antimicrobial agents may be any suitable antimicrobial, such as silver, copper, and/or gold in metallic forms (e.g., particulates, alloys and oxides), salts (e.g., sulfates, nitrates, acetates, citrates, and chlorides) and/or in ionic forms. In some aspects, further additives, e.g., additional antimicrobial agents, are added to the polymer composition.

In some embodiments, the polymer composition (and the fibers or filter formed therefrom) may further comprise an antimicrobial or antiviral coating. For example, a fiber or filter formed from the polymer composition may include a coating of zinc nanoparticles (e.g., nanoparticles of zinc oxide, zinc ammonium adipate, zinc acetate, zinc ammonium carbonate, zinc stearate, zinc phenyl phosphinic acid, or zinc pyrithione, or combinations thereof). To produce such a coating, the surface of polymer composition (e.g., the surface of the fiber and/or filter formed therefrom) may be cationized and coated layer-by layer by stepwise dipping the polymer composition into an anionic polyelectrolyte solution (e.g., comprising poly 4-styrenesulfonic acid) and a solution comprising the zinc nanoparticles. Optionally, the coated polymer composition may be hydrothermally treated in a solution of NH₄OH at 9° C. for 24 h tio immobilize the zinc nanoparticles.

In some cases, the filter media structures described herein do not require the use or inclusion of acids, e.g., citric acid, and/or acid treatment to be effective. Such treatments are known to create static charge/static decay issues. Advantageously, the elimination of the need for acid treatment, thus eliminates the static charge/static decay issues associated with conventional configurations.

### Metal Retention Rate

As noted, the filter media structures have antimicrobial and/or antiviral properties which are robust, durability and/or long-lasting. This may provide permanent (e.g., near-permanent) antimicrobial and/or antiviral properties to the filter media structures. The permanence of these properties allows the filter media structures to extend the useful lifetime of the filtration device.

One metric for assessing the permanence (e.g., near-permanence) of the antimicrobial and/or antiviral properties of the filter media structure is metal retention. As discussed above, the filter media structures may prepared from the disclosed polymer compositions, which may include various metallic compounds (e.g., zinc compound, phosphorus, copper compound, and/or silver compound). The metallic compounds of the polymer compositions may provide antimicrobial and/or antiviral properties to the filter media structure produced therefrom. Thus, retention of the metallic compounds, e.g., after one or more cycles of washing, may provide permanent (e.g., near-permanent) antimicrobial and/or antiviral properties.

Beneficially, filter media structures formed from the disclosed polymer compositions demonstrate relatively high metal retention rate. The metal retention rate may relate to the retention rate of a specific metal in the polymer composition (e.g., zinc retention, copper retention) or to the retention rate of all metals in the polymer composition (e.g., total metal retention).

In some embodiments, the filter media structures formed from the disclosed polymer compositions have a metal retention greater than 65% as measured by a dye bath test, e.g., greater than 75%, greater than 80%, greater than 90%, greater than 95%, greater than 97%, greater than 98%, greater than 99%, greater than 99.9%, greater than 99.99%, greater than 99.999%, greater than 99.9999%, greater than 99.99999% or greater than 99.999999%. In terms of upper limits, the filter media structures may have a metal retention of less than 100%, e.g., less than 99.9%, less than 98%, or less than 95%. In terms of ranges, the filter media structures may have a metal retention may be from 60% to 100%, e.g., from 60% to 99.999999%, from 60% to 99.99999%, from 60% to 99.9999%, from 60% to 99.999% from 60% to 99.999%, from 60% to 99.99%, from 60% to 99.9%, from 60% to 99%, from 60% to 98%, from 60% to 95%, from 65% to 99.999999%, from 65% to 99.99999%, from 65% to 99.9999%, from 65% to 99.999% from 65% to 99.999%, from 65% to 100%, from 65% to 99.99%, from 65% to 99.9%, from 65% to 99%, from 65% to 98%, from 65% to 95%, from 70% to 100%, from 70% to 99.999999%, from 70% to 99.99999%, from 70% to 99.9999%, from 70% to 99.999% from 70% to 99.999%, from 70% to 99.99%, from 70% to 99.9%, from 70% to 99%, from 70% to 98%, from 70% to 95%, from 75% to 100%, from 75% to 99.99%, from 75% to 99.9%, from 75% to 99.999999%, from 75% to 99.99999%, from 75% to 99.9999%, from 75% to 99.999% from 75% to 99.999%, from 75% to 99%, from 75% to 98%, from 75% to 95%, %, from 80% to 99.999999%, from 80% to 99.99999%, from 80% to 99.9999%, from 80% to 99.999% from 80% to 99.999%, from 80% to 100%, from 80% to 99.99%, from 80% to 99.9%, from 80% to 99%, from 80% to 98%, or from 80% to 95%. In some cases, the ranges and limits relate to dye recipes having lower pH values, e.g., less than (and/or including) 5.0, less than 4.7, less than 4.6, or less than 4.5. In some cases, the ranges and limits relate to dye recipes having higher pH values, e.g., greater than (and/or including) 4.0, greater than 4.2, greater than 4.5, greater than 4.7, greater than 5.0, or greater than 5.0.

In some embodiments, the filter media structures formed from the disclosed polymer compositions have a metal retention greater than 40% after a dye bath, e.g., greater than 44%, greater than 45%, greater than 50%, greater than 55%, greater than 60%, greater than 65%, greater than 70%, greater than 75%, greater than 80%, greater than 90%, greater than 95%, or greater than 99%. In terms of upper limits, the filter media structures may have a metal retention of less than 100%, e.g., less than 99.9%, less than 98%, less than 95% or less than 90%. In terms of ranges, the filter media structures may have a metal retention in a range from 40% to 100%, e.g., from 45% to 99.9%, from 50% to 99.9%, from 75% to 99.9%, from 80% to 99%, or from 90% to 98%. In some cases, the ranges and limits relate to dye recipes having higher pH values, e.g., greater than (and/or including) 4.0, greater than 4.2, greater than 4.5, greater than 4.7, greater than 5.0, or greater than 5.0.

In some embodiments, the filter media structures formed from the polymer compositions have a metal retention greater than 20%, e.g., greater than 24%, greater than 25%, greater than 30%, greater than 35%, greater than 40%, greater than 45%, greater than 50%, greater than 55%, or greater than 60%. In terms of upper limits, the filter media structures may have a metal retention of less than 80%, e.g., less than 77%, less than 75%, less than 70%, less than 68%, or less than 65%. In terms of ranges, the filter media structures may have a metal retention ranging from 20% to 80%, e.g., from 25% to 77%, from 30% to 75%, or from 35% to 70%. In some cases, the ranges and limits relate to dye recipes having lower pH values, e.g., less than (and/or including) 5.0, less than 4.7, less than 4.6, or less than 4.5.

Stated another way, in some embodiments, the filter media structures formed from the polymer composition demonstrate an extraction rate of the metal compound less than 35% as measured by the dye bath test, e.g., less than 25%, less than 20%, less than 10%, or less than 5%. In terms of upper limits, the filter media structures may demonstrate an extraction rate of the metal compound greater than 0%, e.g., greater than 0.1%, greater than 2% or greater than 5%. In terms of ranges, the filter media structures may demonstrate an extraction rate of the metal compound from 0% to 35%, e.g., from 0% to 25%, from 0% to 20%, from 0% to 10%, from 0% to 5%, from 0.1% to 35%, from 0.1% to 25%, from 0.1% to 20%, from 0.2% to 10%, from 0.1% to 5%, from 2% to 35%, from 2% to 25%, from 2% to 20%, from 2% to 10%, from 2% to 5%, from 5% to 35%, from 5% to 25%, from 5% to 20%, or from 5% to 10%.

The metal retention of a filter media structure formed from the disclosed polymer compositions may be measured by a dye bath test according to the following standard procedure. A sample is cleaned (all oils are removed) by a scour process. The scour process may employ a heated bath, e.g., conducted at 71° C. for 15 minutes. A scouring solution comprising 0.25% on weight of fiber (“owf”) of Sterox (723 Soap) nonionic surfactant and 0.25% owf of TSP (trisodium phosphate) may be used. The samples are then rinsed with cold water.

The cleaned samples may be tested according a chemical dye level procedure. This procedure may employ placing them in a dye bath comprising 1.0% owf of C.I. Acid Blue 45, 4.0% owf of MSP (monosodium phosphate), and a sufficient % owf of di sodium phosphate or TSP to achieve a pH of 6.0, with a 28:1 liquor to sample ratio. For example, if a pH of less than 6 is desired, a 10% solution of the desired acid may be added using an eye dropper until the desired pH was achieved. The dye bath may be preset to bring the bath to a boil at 100° C. The samples are placed in the bath for 1.5 hours. As one example, it may take approximately 30 minutes to reach boil and hold one hour after boil at this temperature. Then the samples are removed from the bath and rinsed. The samples are then transferred to a centrifuge for water extraction. After water extraction, the samples were laid out to air dry. The component amounts are then recorded.

In some embodiments, the metal retention of a fiber formed from the polymer composition may be calculated by measuring metal content before and after a dye bath operation. The amount of metal retained after the dye bath may be measured by known methods. For the dye bath, an Ahiba dyer (from Datacolor) may be employed. In a particular instance, twenty grams of un-dyed fiber layer and 200 ml of dye liquor may be placed in a stainless steel can, the pH may be adjusted to the desired level, the stainless steel can may be loaded into the dyer; the sample may be heated to 40° C. then heated to 100° C. (optionally at 1.5° C./minute). In some cases a temperature profile may be employed, for example, 1.5° C./minute to 60° C., 1° C./minute to 80° C., and 1.5° C./minute to 100° C. The sample may be held at 100° C. for 45 minutes, followed by cooling to 40° C. at 2° C./minute, then rinsed and dried to yield the dyed product.

In some embodiments, the filter media structure (e.g., one or more layers of the filter media structure) retains AM/AV properties after one or more washing cycles. In some cases, this washfastness may be due to the use of the aforementioned AM/AV formulations employed to make the fibers, e.g., the AM/AV compound may be embedded in the polymer structure. In one embodiment, the filter media structure retains AM/AV properties after more than 1 washing cycle, e.g., more than 2 washing cycles, more than 5 washing cycles, more than 10 washing cycles, or more than 20 washing cycle. The durability of the disclosed filters, including the individual layers, is also demonstrated via retention after dyeing operations.

The washfastness may also be described by the metal retention (e.g., zinc retention) after a number of wash cycles. In some embodiments, for example, the filter media structure retains greater than 95% of a metallic compound (e.g., a zinc compound) after 5 wash cycles, e.g., greater than 96%, greater than 97%, or greater than 98%. In some embodiments, the filter media structure retains greater than 85% of a metallic compound (e.g., a zinc compound) after 10 wash cycles, e.g., greater than 86%, greater than 87%, greater than 88%, greater than 89%, or greater than 90%.

In some cases, the filter media structures may be used in wound care, for example, the filter media structures may be employed as wraps, (breathable) gauzes, bandages, and/or other dressings. The AM/AV properties of the filter media structures make them particularly beneficial in these applications. In some cases, the filter media structures serve as a moisture barrier and/or to facilitate an oxygen transmission balance.

### Method of Forming Fibers and Nonwoven Layers

As described herein, the fibers or nonwoven layers of the filter media structure are made by forming the AM/AV polymer composition into the fibers, which are arranged to form the filter media structure.

In some aspects, fibers, e.g., polyamide fibers, are made by spinning a polyamide composition formed in a melt polymerization process. During the melt polymerization process of the polyamide composition, an aqueous monomer solution, e.g., salt solution, is heated under controlled conditions of temperature, time and pressure to evaporate water and effect polymerization of the monomers, resulting in a polymer melt. During the melt polymerization process, sufficient amounts of zinc and, optionally, phosphorus, are employed in the aqueous monomer solution to form the polyamide mixture before polymerization. The monomers are selected based on the desired polyamide composition. After zinc and phosphorus are present in the aqueous monomer solution, the polyamide composition may be polymerized. The polymerized polyamide can subsequently be spun into fibers, e.g., by melt, solution, centrifugal, or electro-spinning.

In some embodiments, the process for preparing fibers having permanent AM/AV properties from the polyamide composition includes preparing an aqueous monomer solution, adding less than 20,000 wppm of one or more metallic compounds dispersed within the aqueous monomer solution, e.g., less than 17,500 wppm, less than 17,000 wppm, less than 16,500 wppm, less than 16,000 wppm, less than 15,500 wppm, less than 15,000 wppm, less than 12,500 wppm, less than 10,000 wppm, less than 5000 wppm, less than less than 4000 wppm, less than 3000 wppm, less than 2000 wppm, less than 1000 wppm, or less than 500 wppm, polymerizing the aqueous monomer solution to form a polymer melt, and spinning the polymer melt to form an AM/AV fiber. In this embodiment, the polyamide composition comprises the resultant aqueous monomer solution after the metallic compound(s) are added.

In some embodiments, the process includes preparing an aqueous monomer solution. The aqueous monomer solution may comprise amide monomers. In some embodiments, the concentration of monomers in the aqueous monomer solution is less than 60 wt %, e.g., less than 58 wt %, less than 56.5 wt %, less than 55 wt %, less than 50 wt %, less than 45 wt %, less than 40 wt %, less than 35 wt %, or less than 30 wt %. In some embodiments, the concentration of monomers in the aqueous monomer solution is greater than 20 wt %, e.g., greater than 25 wt %, greater than 30 wt %, greater than 35 wt %, greater than 40 wt %, greater than 45 wt %, greater than 50 wt %, greater than 55 wt %, or greater than 58 wt %. In some embodiments, the concentration of monomers in the aqueous monomer solution is in a range from 20 wt % to 60 wt %, e.g., from 25 wt % to 58 wt %, from 30 wt % to 56.5 wt %, from 35 wt % to 55 wt %, from 40 wt % to 50 wt %, or from 45 wt % to 55 wt %. The balance of the aqueous monomer solution may comprise water and/or additional additives. In some embodiments, the monomers comprise amide monomers including a diacid and a diamine, i.e., nylon salt.

In some embodiments, the aqueous monomer solution is a nylon salt solution. The nylon salt solution may be formed by mixing a diamine and a diacid with water. For example, water, diamine, and dicarboxylic acid monomer are mixed to form a salt solution, e.g., mixing adipic acid and hexamethylene diamine with water. In some embodiments, the diacid may be a dicarboxylic acid and may be selected from the group consisting of oxalic acid, malonic acid, succinic acid, glutaric acid, pimelic acid, adipic acid, suberic acid, azelaic acid, sebacic acid, undecanedioic acid, dodecandioic acid, maleic acid, glutaconic acid, traumatic acid, and muconic acid, 1,2- or 1,3-cyclohexane dicarboxylic acids, 1,2- or 1,3-phenyl enediacetic acids, 1,2- or 1,3-cyclohexane diacetic acids, isophthalic acid, terephthalic acid, 4,4′-oxybisbenzoic acid, 4,4-benzophenone dicarboxylic acid, 2,6-napthalene dicarboxylic acid, p-t-butyl isophthalic acid and 2,5-furandicarboxylic acid, and mixtures thereof. In some embodiments, the diamine may be selected from the group consisting of ethanol diamine, trimethylene diamine, putrescine, cadaverine, hexamethyelene diamine, 2-methyl pentamethylene diamine, heptamethylene diamine, 2-methyl hexamethylene diamine, 3-methyl hexamethylene diamine, 2,2-dimethyl pentamethylene diamine, octamethylene diamine, 2,5-dimethyl hexamethylene diamine, nonamethylene diamine, 2,2,4- and 2,4,4-trimethyl hexamethylene diamines, decamethylene diamine, 5-methylnonane diamine, isophorone diamine, undecamethylene diamine, dodecamethylene diamine, 2,2,7,7-tetramethyl octamethylene diamine, bis(p-aminocyclohexyl)methane, bis(aminomethyl)norbornane, C2-C16 aliphatic diamine optionally substituted with one or more C1 to C4 alkyl groups, aliphatic polyether diamines and furanic diamines, such as 2,5-bis(aminomethyl)furan, and mixtures thereof. In preferred embodiments, the diacid is adipic acid and the diamine is hexamethylene diamine which are polymerized to form nylon 6,6.

It should be understood that the concept of producing a polyamide from diamines and diacids also encompasses the concept of other suitable monomers, such as, aminoacids or lactams. Without limiting the scope, examples of aminoacids can include 6-aminohaxanoic acid, 7-aminoheptanoic acid, 11-aminoundecanoic acid, 12-aminododecanoic acid, or combinations thereof. Without limiting the scope of the disclosure, examples of lactams can include caprolactam, enantholactam, lauryllactam, or combinations thereof. Suitable feeds for the disclosed process can include mixtures of diamines, diacids, aminoacids and lactams.

After the aqueous monomer solution is prepared, a metallic compound (e.g., a zinc compound, a copper compound, and/or a silver compound) is added to the aqueous monomer solution to form the polyamide composition. In some embodiments, less than 20,000 ppm of the metallic compound by weight is dispersed within the aqueous monomer solution. In some aspects, further additives, e.g., additional AM/AV agents, are added to the aqueous monomer solution. Optionally, phosphorus (e.g., a phosphorus compound) is added to the aqueous monomer solution.

In some cases, the polyamide composition is polymerized using a conventional melt polymerization process. In one aspect, the aqueous monomer solution is heated under controlled conditions of time, temperature, and pressure to evaporate water, effect polymerization of the monomers and provide a polymer melt. In some aspects, the particular weight ratio of zinc to phosphorus may advantageously promote binding of zinc within the polymer, reduce thermal degradation of the polymer, and enhance its dyeability.

In one embodiment, a nylon is prepared by a conventional melt polymerization of a nylon salt. Typically, the nylon salt solution is heated under pressure (e.g. 250 psig/1825×10³ n/m²) to a temperature of, for example, about 245° C. Then the water vapor is exhausted off by reducing the pressure to atmospheric pressure while increasing the temperature to, for example, about 270° C. Before polymerization, zinc and, optionally, phosphorus be added to the nylon salt solution. The resulting molten nylon is held at this temperature for a period of time to bring it to equilibrium prior to being extruded into a fiber. In some aspects, the process may be carried out in a batch or continuous process.

In some embodiments, during melt polymerization, zinc, e.g., zinc oxide is added to the aqueous monomer solution. The AM/AV fiber may comprise a polyamide that is made in a melt polymerization process and not in a master batch process. In some aspects, the resulting fiber has permanent AM/AV properties. The resulting fiber can be used in the first layer, the second layer, and/or the third layer of the filter media structure.

The AM/AV agent may be added to the polyamide during melt polymerization, for example as a master batch or as a powder added to the polyamide pellets, and thereafter, the fiber may be formed from spinning. The fibers are then formed into a nonwoven.

In some aspects, the AM/AV nonwoven structure is melt blown. Melt blowing is advantageously less expensive than electrospinning. Melt blowing is a process type developed for the formation of microfibers and nonwoven webs. Until recently, microfibers have been produced by melt blowing. Now, nanofibers may also be formed by melt blowing. The nanofibers are formed by extruding a molten thermoplastic polymeric material, or polyamide, through a plurality of small holes. The resulting molten threads or filaments pass into converging high velocity gas streams which attenuate or draw the filaments of molten polyamide to reduce their diameters. Thereafter, the melt blown nanofibers are carried by the high velocity gas stream and deposited on a collecting surface, or forming wire, to form a nonwoven web of randomly disbursed melt blown nanofibers. The formation of nanofibers and nonwoven webs by melt blowing is well known in the art. See, e.g., U.S. Pat. Nos. 3,704,198; 3,755,527; 3,849,241; 3,978,185; 4,100,324; and 4,663,220.

One option, “Island-in-the-sea,” refers to fibers forming by extruding at least two polymer components from one spinning die, also referred to as conjugate spinning.

As is well known, electrospinning has many fabrication parameters that may limit spinning certain materials. These parameters include: electrical charge of the spinning material and the spinning material solution; solution delivery (often a stream of material ejected from a syringe); charge at the jet; electrical discharge of the fibrous membrane at the collector; external forces from the electrical field on the spinning jet; density of expelled jet; and (high) voltage of the electrodes and geometry of the collector. In contrast, the aforementioned nanofibers and products are advantageously formed without the use of an applied electrical field as the primary expulsion force, as is required in an electrospinning process. Thus, the polyamide is not electrically charged, nor are any components of the spinning process. Importantly, the dangerous high voltage necessary in electrospinning processes, is not required with the presently disclosed processes/products. In some embodiments, the process is a non-electrospin process and resultant product is a non-electrospun product that is produced via a non-electrospin process.

Another embodiment of making the nanofiber nonwovens is by way of 2-phase spinning or melt blowing with propellant gas through a spinning channel as is described generally in U.S. Pat. No. 8,668,854. This process includes two phase flow of polymer or polymer solution and a pressurized propellant gas (typically air) to a thin, preferably converging channel. The channel is usually and preferably annular in configuration. It is believed that the polymer is sheared by gas flow within the thin, preferably converging channel, creating polymeric film layers on both sides of the channel. These polymeric film layers are further sheared into nanofibers by the propellant gas flow. Here again, a moving collector belt may be used and the basis weight of the nanofiber nonwoven is controlled by regulating the speed of the belt. The distance of the collector may also be used to control fineness of the nanofiber nonwoven.

Beneficially, the use of the aforementioned polyamide precursor in the melt spinning process provides for significant benefits in production rate, e.g., at least 5% greater, at least 10% greater, at least 20% greater, at least 30% greater, at least 40% greater. The improvements may be observed as an improvement in area per hour versus a conventional process, e.g., another process that does not employ the features described herein. In some cases, the production increase over a consistent period of time is improved. For example, over a given time period, e.g., one hour, of production, the disclosed process produces at least 5% more product than a conventional process or an electrospin process, e.g., at least 10% more, at least 20% more, at least 30% more, or at least 40% more.

Still yet another methodology which may be employed is melt blowing. Melt blowing involves extruding the polyamide into a relatively high velocity, typically hot, gas stream. To produce suitable nanofibers, careful selection of the orifice and capillary geometry as well as the temperature is required as is seen in: Hassan et al., J Membrane Sci., 427, 336-344, 2013 and Ellison et al., Polymer, 48 (11), 3306-3316, 2007, and, International Nonwoven Journal, Summer 2003, pg. 21-28.

U.S. Pat. No. 7,300,272 (incorporated herein by reference) discloses a fiber extrusion pack for extruding molten material to form an array of nanofibers that includes a number of split distribution plates arranged in a stack such that each split distribution plate forms a layer within the fiber extrusion pack, and features on the split distribution plates form a distribution network that delivers the molten material to orifices in the fiber extrusion pack. Each of the split distribution plates includes a set of plate segments with a gap disposed between adjacent plate segments. Adjacent edges of the plate segments are shaped to form reservoirs along the gap, and sealing plugs are disposed in the reservoirs to prevent the molten material from leaking from the gaps. The sealing plugs can be formed by the molten material that leaks into the gap and collects and solidifies in the reservoirs or by placing a plugging material in the reservoirs at pack assembly. This pack can be used to make nanofibers with a melt blowing system described in the patents previously mentioned. The systems and method of U.S. Pat. No. 10,041,188 (incorporated herein by reference) are also exemplary.

In one embodiment, a process for preparing the AM/AV nonwoven polyamide structure (e.g., for use in the first layer, the second layer, and/or the third layer) is disclosed. The process comprising the step of forming a (precursor) polyamide (preparation of monomer solutions are well known), e.g., by preparing an aqueous monomer solution. During preparation of the precursor, a metallic compound is added (as discussed herein). In some cases, the metallic compound is added to (and dispersed in) the aqueous monomer solution. Phosphorus may also be added. In some cases, the precursor is polymerized to form a polyamide composition. The process further comprises the steps of forming polyamide fibers and forming the AM/AV polyamide fibers into a structure. In some cases, the polyamide composition is melt spun, spunbonded, electrospun, solution spun, or centrifugally spun.

The filter media structure disclosed herein can be incorporated into various applications, including both liquid and air filtration applications for surface-type filters and depth-type filters. Exemplary uses include HVAC filters, residential furnace filters, cabin air filters, automotive air intake filters, respirator filters, bag filters, dust bag house filters, paint spray booth filters, surgical face masks, industrial face masks, automotive fuel filters, automotive lube filters, room air cleaner filters, vacuum cleaner exhaust filters, as well as other commercial filter uses.

### Exemplary Configurations

The filter media structure of the present disclosure may comprise any combination of the first layer is an electret web, the second layer having biological-reducing properties, and (optionally) further layers, as described above. In some embodiments, the second layer may be upstream or downstream relative to the first layer. By way of example and without limiting the scope of the disclosure, several configurations are described herein. By way of further example, several configurations are illustrated in the following table, wherein the further layer is a scrim.

TABLE 1
Exemplary Configurations

| Upstream | Middle | Downstream |
|---|---|---|
| Meltblown Polyamide | Meltblown polyamide | Spunbond |
| Scrim | microfiber | polypropylene |
| Meltblown Polyamide | Meltblown polyamide | Spunbond |
| Scrim | nanofiber | polypropylene |
| Meltblown Polyamide | Meltblown polyamide | Meltblown |
| Scrim | microfiber | polypropylene |
| Meltblown Polyamide | Meltblown polyamide | Meltblown |
| Scrim | nanofiber | polypropylene |
| Meltblown Polyamide | Meltblown polyamide | Adhesive bonded |
| Scrim | microfiber | polyethylene |
| | | terephthalate |
| Meltblown Polyamide | Meltblown polyamide | Adhesive bonded |
| Scrim | nanofiber | polyethylene |
| | | terephthalate |
| Meltblown Polyamide | Meltblown polyamide | Meltblown |
| Scrim | microfiber | polypropylene/ |
| | | Adhesive |
| | | bonded polyethylene |
| | | terephthalate |
| Meltblown Polyamide | Meltblown polyamide | Spunbond |
| Scrim | microfiber | polypropylene/ |
| | | Needle felt |
| | | polypropylene |
| Meltblown Polyamide | Meltblown polyamide | Spunbond |
| Scrim | nanofiber | polypropylene/ |
| | | Needle felt |
| | | polypropylene |
| Spunbond polypropylene | Meltblown Polyamide | Meltblown polyamide |
| | Scrim | microfiber |
| Spunbond polypropylene | Meltblown Polyamide | Meltblown polyamide |
| | Scrim | nanofiber |
| Meltblown polypropylene | Meltblown Polyamide | Meltblown polyamide |
| | Scrim | microfiber |
| Meltblown polypropylene | Meltblown Polyamide | Meltblown polyamide |
| | Scrim | nanofiber |
| Adhesive bonded | Meltblown Polyamide | Meltblown polyamide |
| polyethylene terephthalate | Scrim | microfiber |
| Adhesive bonded | Meltblown Polyamide | Meltblown polyamide |
| polyethylene terephthalate | Scrim | nanofiber |
| Meltblown | Meltblown Polyamide | Meltblown polyamide |
| polypropylene/Adhesive | Scrim | microfiber |
| bonded polyethylene | | |
| terephthalate | | |
| Meltblown | Meltblown Polyamide | Meltblown polyamide |
| polypropylene/Adhesive | Scrim | nanofiber |
| bonded polyethylene | | |
| terephthalate | | |
| Spunbond polypropylene/ | Meltblown Polyamide | Meltblown polyamide |
| Needle felt polypropylene | Scrim | microfiber |
| Spunbond polypropylene/ | Meltblown Polyamide | Meltblown polyamide |
| Needle felt polypropylene | Scrim | nanofiber |
| Spunbond polypropylene | Meltblown polyamide | Meltblown Polyamide |
| | microfiber | Scrim |
| Spunbond polypropylene | Meltblown polyamide | Meltblown Polyamide |
| | nanofiber | Scrim |
| Meltblown polypropylene | Meltblown polyamide | Meltblown Polyamide |
| | microfiber | Scrim |
| Meltblown polypropylene | Meltblown polyamide | Meltblown Polyamide |
| | nanofiber | Scrim |
| Adhesive bonded | Meltblown polyamide | Meltblown Polyamide |
| polyethylene terephthalate | microfiber | Scrim |
| Adhesive bonded | Meltblown polyamide | Meltblown Polyamide |
| polyethylene terephthalate | nanofiber | Scrim |
| Meltblown | Meltblown polyamide | Meltblown Polyamide |
| polypropylene/Adhesive | microfiber | Scrim |
| bonded polyethylene | | |
| terephthalate | | |
| Meltblown | Meltblown polyamide | Meltblown Polyamide |
| polypropylene/Adhesive | nanofiber | Scrim |
| bonded polyethylene | | |
| terephthalate | | |
| Spunbond polypropylene/ | Meltblown polyamide | Meltblown Polyamide |
| Needle felt polypropylene | microfiber | Scrim |
| Spunbond polypropylene/ | Meltblown polyamide | Meltblown Polyamide |
| Needle felt polypropylene | nanofiber | Scrim |
| Meltblown | Meltblown Polyamide | Spunbond polyamide |
| polypropylene/Adhesive | Scrim | |
| bonded polyethylene | | |
| terephthalate | | |
| Spunbond polypropylene/ | Meltblown Polyamide | Spunbond polyamide |
| Needle felt polypropylene | Scrim | |
| Spunbond polypropylene | Spunbond polyamide | Meltblown Polyamide |
| | | Scrim |
| Meltblown polypropylene | Spunbond polyamide | Meltblown Polyamide |
| | | Scrim |
| Adhesive bonded | Spunbond polyamide | Meltblown Polyamide |
| polyethylene terephthalate | | Scrim |
| Meltblown | Spunbond polyamide | Meltblown Polyamide |
| polypropylene/Adhesive | | Scrim |
| bonded polyethylene | | |
| terephthalate | | |
| Spunbond polypropylene/ | Spunbond polyamide | Meltblown Polyamide |
| Needle felt polypropylene | | Scrim |

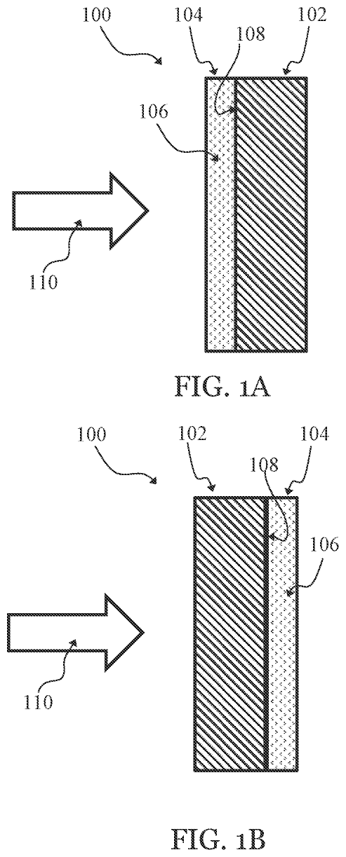

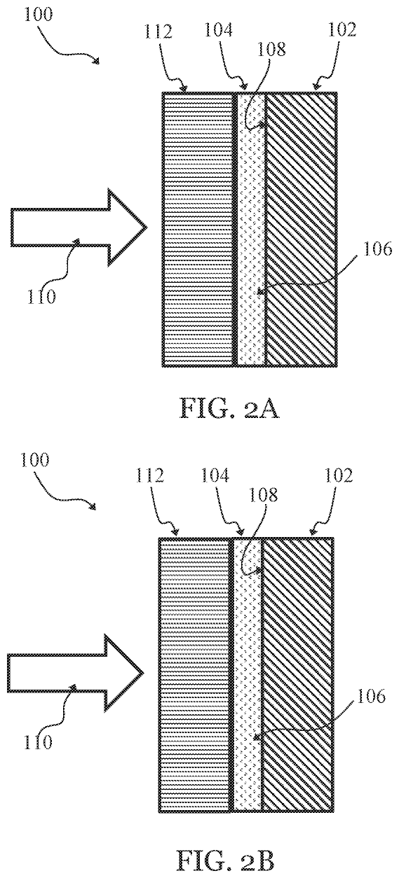

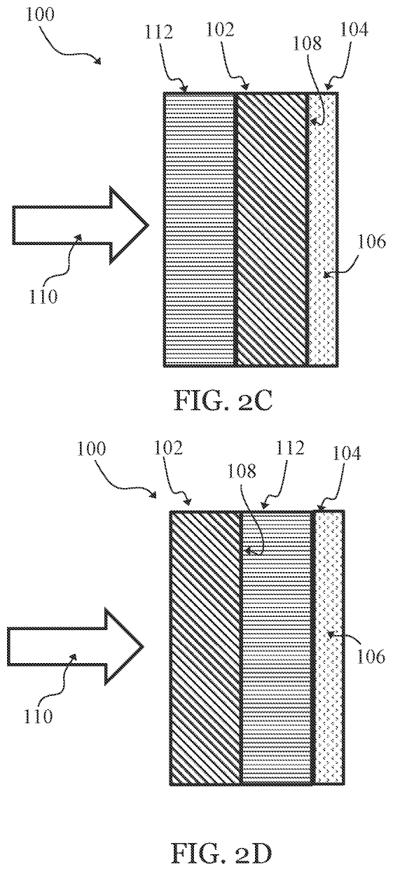

By way of further examples, several configurations are illustrated in the drawings. FIGS. 1A and 1B illustrates the configuration of a filter media structure 100 having a first layer 102, a second layer 104 having AV/AM compound, described herein, preferably zinc. First layer 102 is an electret web. Second layer 104 in FIG. 1A is positioned upstream on first surface 108 relative to the stream 110. FIG. 1B shows a downstream configuration. It should be understood that first layer may comprise multiple layers. FIGS. 2A-2D illustrates the configuration of a filter media structure 100 having a first layer 102, a second layer 104 and a third layer 112, preferably a scrim. In FIGS. 2A-2C, the second layer 104 is adjacent to the first layer 102, while in FIG. 2D the third layer 112 is positioned between the first layer 102 and second layer 104. In some embodiments, there may be multiple third layers. Although these configuration are shown for illustration purposes other configurations of the layers are contemplated by the embodiments of this disclosure. Other layers or binding agents may be used for the configuration in a suitable manner.

The present disclosure is further understood by the following non-limiting examples.

### EXAMPLES

Efficiency was measured using the TSI 8130 test of the spunbond polypropylene and meltblown polyamide alone and compared with the filter media structure. Efficiency (NaCl permeability) is determined using a TSI 8130 tester. A 2 wt % sodium chloride aqueous solution was used to generate fine aerosol with a mass mean diameter of about 0.3 micron. The air flow rate was 86 liter/min.

MERV (Minimum Efficiency Reporting Value) ratings are used to describe a filter's ability to remove particulates from the air. The MERV rating is derived from the efficiency of the filter versus particles in various size ranges, and is calculated according to methods detailed in ASHRAE 52.2: E1 (0.3-1.0 Microns); E2 (1.0-3.0 Microns); and E3 (3.0-10.0 Microns). A higher MERV rating means better filtration and greater performance.

### Example 1

A filter media structure was prepared using a 77.2 g/m² spunbond polypropylene (SBPP) charged two-layer nonwoven layer having an average fiber diameter of 13 microns, thickness of 0.65 mm on which a 17 g/m² meltblown polyamide (MBPA) having an average fiber diameter of about 1.5 to 2 microns was positioned in an upstream manner. The meltblown polyamide comprised 500 ppm of zinc by weight (wppm). A polyamide scrim was further positioned upstream of the polyamide layer.

### Example 2

Example 1 was repeated except the meltblown polyamide was positioned downstream of the spunbond polypropylene.

### Example 3

Example 1 was repeated except that a 10 g/m² meltblown polyamide having an average fiber diameter of about 400 to 500 nanometers was positioned in an upstream manner on the spunbond polypropylene. This meltblown polyamide comprised 500 ppm of zinc by weight (wppm).

### Example 4

Example 3 was repeated except the meltblown polyamide was positioned downstream of the spunbond polypropylene.

### Comparative Examples A-C

Comparative Examples A-C were configured as single layers.

The filter media structures for Examples 1-4 and Comparative Examples A-C were tested for efficiency and biology-reducing properties. MERV testing was performed as well. The results are shown in Table 2. Importantly, the filter media retained its charge as observed by the improved efficiency, which is also reported in Table 2. For comparison, the individual lavers were also tested.

TABLE 2

| | | | TSI 8130 | | | | |
|---|---|---|---|---|---|---|---|
| Exam- | Up- | Down- | Efficiency | ASHRAE 52.2 | | | |
| ples | stream | stream | (%) | E1 | E2 | E3 | MERV |
| A | | SBPP | 97.29 | 93.00 | 99.60 | 99.900 | 15 |
| B | MBPA | | 35.7 | 58.00 | 96.00 | 99.900 | 13 |
| C | MBPA | | 47.2 | 71.00 | 97.00 | 99.900 | 13 |
| 1 | MBPA | SBPP | 98.36 | | | | |
| 2 | SBPP | MBPA | 98.46 | 87.00 | 99.60 | 99.995 | 15 |
| 3 | MBPA | SBPP | 98.12 | | | | |
| 4 | SBPP | MBPA | 98.71 | 92.00 | 99.90 | 100.000 | 15 |

### Example 5

A filter media structure was prepared using a nonwoven layer having a spunbond polypropylene (average fiber diameter of 28.3 microns) and needle felt polypropylene (NFPP) (average fiber diameter of 16.9 microns), which had a basis weight of 92.4 g/m² and a thickness of 1.07 mm on which a 17 g/m² meltblown polyamide used in Example 1. A polyamide scrim was further positioned upstream of the meltblown polyamide layer.

### Example 6

Example 5 was repeated except the meltblown polyamide was positioned downstream of the nonwoven layer.

### Example 7

Example 5 was repeated except that a 10 g/m² meltblown polyamide used in Example 3 on the nonwoven layer.

### Example 8

Example 7 was repeated except the meltblown polyamide was positioned downstream of the nonwoven layer.

The filter media structures for examples 5-8 demonstrated biology-reducing properties and filter media retained the charge and the efficiencies are reported in Table 3. For comparison, Comparative Examples B and C along with Comparative D (a SBPP/NFPP configuration with no AM/AV compound) were also tested. MERV testing was done for the individual lavers and Examples 6 and 8.

TABLE 3

| | | | TSI 8130 | | | | |
|---|---|---|---|---|---|---|---|
| Exam- | Up- | Down- | Efficiency | ASHRAE 52.2 | | | |
| ples | stream | stream | (%) | E1 | E2 | E3 | MERV |
| D | | SBPP/ | 84.55 | 53.00 | 83.00 | 96.000 | 12 |
| | | NFPP | | | | | |
| B | MBPA | | 35.7 | 58.00 | 96.00 | 99.900 | 13 |
| C | MBPA | | 47.2 | 71.00 | 97.00 | 99.900 | 13 |
| 5 | MBPA | SBPP | 90.71 | | | | |
| 6 | SBPP | MBPA | 90.00 | 73.00 | 98.00 | 99.980 | 13 |
| 7 | MBPA | SBPP | 92.04 | | | | |
| 8 | SBPP | MBPA | 90.81 | 85.30 | 99.60 | 99.999 | 15 |

### Example 9

A filter media structure was prepared using a nonwoven layer having a 2.3 g/m² of meltblown polypropylene and a 36.4 g/m² adhesive bonded polyethylene terephthalate (ABPET), which had a thickness of 0.71 mm on which a 17 g/m² meltblown polyamide from Example 1 was positioned in an upstream manner. A polyamide scrim was further positioned upstream of the meltblown polyamide layer. The filter media structure demonstrated an improved efficiency (TSI 8130) of 99.94%, which is greater than the nonwoven layer alone or the meltblown polyamide alone, see Tables 4 and 5.

### Example 10

Example 9 was repeated except the meltblown polyamide was positioned downstream of the nonwoven layer. The filter media structure demonstrated an improved efficiency (TSI 8130) of 99.85%.

### Example 11

Example 9 was repeated except that a 10 g/m² meltblown polyamide of Example 3 was positioned in an upstream manner on the nonwoven layer. The filter media structure demonstrated an improved efficiency (TSI 8130) of 99.92%.

### Example 12

Example 11 was repeated except the meltblown polyamide was positioned downstream of the nonwoven layer. The filter media structure demonstrated an improved efficiency (TSI 8130) of 99.82%.

### Example 13

A filter media structure was prepared using a nonwoven layer having an adhesive bonded polyethylene terephthalate (ABPET) (average fiber diameter of 2.6 microns) and meltblown polypropylene (MBPP) (average fiber diameter of 14.9 microns), which had a basis weight of 158.3 g/m² and a thickness of 1.27 mm on which a 17 g/m² meltblown polyamide of Example 1 was positioned in an upstream manner. A polyamide scrim was further positioned upstream of the meltblown polyamide layer. The filter media structure demonstrated an improved efficiency (TSI 8130) of 99.96%, which is greater than the nonwoven layer alone or the meltblown polyamide alone, see Tables 4 and 5.

### Example 14

Example 13 was repeated except the meltblown polyamide was positioned downstream of the nonwoven layer. The filter media structure demonstrated an improved efficiency (TSI 8130) of 99.91%.

### Example 15

Example 13 was repeated except that a 10 g/m² meltblown polyamide of Example 3 was positioned in an upstream manner on the nonwoven layer. The filter media structure demonstrated an improved efficiency (TSI 8130) of 99.95%.

### Example 16

Example 15 was repeated except the meltblown polyamide was positioned downstream of the nonwoven layer. The filter media structure demonstrated an improved efficiency (TSI 8130) of 99.96%.

### Example 17

A filter media structure was prepared using a nonwoven layer having a 17.7 g/m² of meltblown polypropylene, which had an average fiber diameter of 2-7 microns and a thickness of 0.15 mm on which a 17 g/m² meltblown polyamide of Example 1 was positioned in a downstream manner. A polyamide scrim was further positioned upstream of the meltblown polyamide layer. The filter media structure demonstrated an improved efficiency (TSI 8130) of 86.3%.

### Example 18

Example 17 was repeated except that a 10 g/m² meltblown polyamide of Example 3. The filter media structure demonstrated an improved efficiency (TSI 8130) of 87.5%.

### Example 19

A filter media structure was prepared using a nonwoven layer having a 19.7 g/m² of meltblown polypropylene, which had an average fiber diameter of 2-7 microns and a thickness of 0.18 mm on which a 17 g/m² meltblown polyamide of Example 1 was positioned in a downstream manner. A polyamide scrim was further positioned upstream of the meltblown polyamide layer. The filter media structure demonstrated an improved efficiency (TSI 8130) of 95.3%.

### Example 20

Example 19 was repeated except that a 10 g/m² meltblown polyamide of Example 3 was positioned in an upstream manner on the nonwoven layer. The filter media structure demonstrated an improved efficiency (TSI 8130) of 95.3%.

### Example 21

A filter media structure was prepared using a nonwoven layer having a 28.9 g/m² of meltblown polypropylene, which had an average fiber diameter of 2-7 microns and a thickness of 0.25 mm on which a 17 g/m² meltblown polyamide of Example 1 was positioned in a downstream manner. The meltblown polyamide comprised 500 wppm of zinc. A polyamide scrim was further positioned upstream of the meltblown polyamide layer. The filter media structure demonstrated an improved efficiency (TSI 8130) of 95%.

### Example 22

Example 21 was repeated except that a 10 g/m² meltblown polyamide of Example 3 was positioned in an upstream manner on the nonwoven layer. The filter media structure demonstrated an improved efficiency (TSI 8130) of 95.4%, and a pressure drop of 5.04 mm H₂O.

Table 4 shows compares the results from Examples 9-18. In addition, it was observed that the filer media structures had improved efficiency by using a polyamide layer having biological-reducing properties.

TABLE 4

| | | | TSI 8130 |
|---|---|---|---|
| | | | Efficiency |
| Examples | Upstream | Downstream | (%) |
| 9 | MBPA | MBPP/ABPET | 99.94 |
| 10 | MBPP/ABPET | MBPA | 99.85 |
| 11 | MBPA | MBPP/ABPET | 99.92 |
| 12 | MBPP/ABPET | MBPA | 99.82 |
| 13 | MBPA | ABPET/MBPP | 99.96 |
| 14 | ABPET/MBPP | MBPA | 99.91 |
| 15 | MBPA | ABPET/MBPP | 99.95 |
| 16 | ABPET/MBPP | MBPA | 99.96 |
| 17 | MBPP | MBPA | 86.3 |
| 18 | MBPP | MBPA | 87.5 |
| 19 | MBPP | MBPA | 95.3 |
| 20 | MBPP | MBPA | 95.3 |
| 21 | MBPP | MBPA | 95.0 |
| 22 | MBPP | MBPA | 95.4 |

Table 5 shows the results of the individual layers used in the filter media in the examples. As shown, the efficiency measurements for the Examples in Table 4 are generally significantly higher than those for Comparative Examples A-H in Table 5 when the layers are constructed in as in examples 9-16. Even examples 17-22 show an improved efficiency over individual layers.

TABLE 5

| | | Basis | Fiber | TSI 8130 |
|---|---|---|---|---|
| | | Weight | Diameter | Efficiency |
| | Polymer | (g/m²) | (microns) | (%) |
| A | SBPP | 77.1 | 13 | 97.29 |
| B | MBPA | 17 | 1.5-2 | 35.7 |
| C | MBPA | 10 | 0.4-0.5 | 47.2 |
| D | SBPP/NFPP | 92.4 | 28.3/16.9 | 84.55 |
| E | ABPET/MBPP | 158.3 | 2.6/14.9 | 99.8 |
| F | MBPP | 17.7 | 2-7 | 73.0 |
| G | MBPP | 19.7 | 2-7 | 85.4 |
| H | MBPP | 28.9 | 2-7 | 91.8 |

### Embodiments

As used below, any reference to a series of embodiments is to be understood as a reference to each of those embodiments disjunctively (e.g., “Embodiments 1-4” is to be understood as “Embodiments 1, 2, 3, or 4”).

Embodiment 1 is a filter media structure for purifying a stream comprising:

a first layer having a first surface and second surface, wherein the first layer comprises a polymer, preferably polyolefin, polyester, polyurethane, polycarbonate, polystyrene, fluoropolymer, or copolymers or blends thereof; and

a second layer adjacent to the first surface, wherein second layer comprises:
from 50 to 99.9 wt. % of polymer fibers, preferably polyamide fibers, based on the total weight of the second layer, preferably each having a fiber diameter from 0.01 microns to 10 microns, and
from 1 wppm to 30,000 wppm of a metallic compound comprising copper, zinc, or silver, or combinations thereof, and

wherein at least one of the second layer demonstrates biological-reducing properties.

Embodiment 2 is a filter media structure of embodiment 1, wherein the first layer has a basis weight of not less than 10 g/m².

Embodiment 3 is a filter media structure of any one of the preceding embodiments, wherein the first layer is an electrically-charged nonwoven web.

Embodiment 4 is a filter media structure of any one of the preceding embodiments, wherein the first layer comprises polyethylene (PE), polypropylene (PP), polybutylene (PB), poly-4-methylpentene (PMP), polyethylene terephthalate (PET), polybutylene terephthalate (PBT), polytrimethyl terephthalate (PTT), poly (ethylene-vinyl acetate) (PEVA), polyvinyl chloride (PVC), polystyrene (PS), polymethylmethacrylate (PMMA), polytrifluorochloroethylene (PCTFE) or combinations thereof.

Embodiment 5 is a filter media structure of any one of the preceding embodiments, wherein the average fiber diameter of the first layer is from 1 to 100 micrometers.

Embodiment 6 is a filter media structure of any one of the preceding embodiments, wherein the second layer is positioned upstream of the first layer.

Embodiment 7 is a filter media structure of any one of the preceding embodiments, wherein the second layer is positioned downstream of the first layer.

Embodiment 8 is a filter media structure of any one of the preceding embodiments, wherein the second layer comprises from 65 to 99.9 wt. % of polymer fibers, preferably from 65 to 99.9 wt. % of polyamide fibers.

Embodiment 9 is a filter media structure of any one of the preceding embodiments, wherein the second layer comprises from 5 wppm to 20,000 wppm of a metallic compound.

Embodiment 10 is a filter media structure of any one of the preceding embodiments, wherein the second layer comprises from 200 wppm to 500 wppm of a metallic compound.

Embodiment 11 is a filter media structure of any one of the preceding embodiments, wherein the metallic compound comprises zinc oxide, zinc ammonium adipate, zinc acetate, zinc ammonium carbonate, zinc stearate, zinc phenyl phosphinic acid, or zinc pyrithione, or combinations thereof.

Embodiment 12 is a filter media structure of any one of the preceding embodiments, wherein the metallic compound comprises copper oxide, copper ammonium adipate, copper acetate, copper ammonium carbonate, copper stearate, copper phenyl phosphinic acid, or copper pyrithione, or combinations thereof.

Embodiment 13 is a filter media structure of any one of the preceding embodiments, wherein the metallic compound comprises silver oxide, silver ammonium adipate, silver acetate, silver ammonium carbonate, silver stearate, silver phenyl phosphinic acid, or silver pyrithione, or combinations thereof.

Embodiment 14 is a filter media structure of any one of the preceding embodiments, wherein the average fiber diameter of the second layer is less than 1 micron.

Embodiment 15 is a filter media structure of any one of the preceding embodiments, wherein the second layer comprises less than 1 wt. % of a phosphorus compound.

Embodiment 16 is a filter media structure of embodiment 15, wherein the second layer comprises from 50 wppm to 10,000 wppm of the phosphorus compound.

Embodiment 17 is a filter media structure of embodiment 15, wherein the phosphorus compound comprises benzene phosphinic acid, diphenylphosphinic acid, sodium phenylphosphinate, phosphorous acid, benzene phosphonic acid, calcium phenylphosphinate, potassium B-pentylphosphinate, methylphosphinic acid, manganese hypophosphite, sodium hypophosphite, monosodium phosphate, hypophosphorous acid, dimethylphosphinic acid, ethylphosphinic acid, diethylphosphinic acid, magnesium ethylphosphinate, triphenyl phosphite, diphenylmethyl phosphite, dimethylphenyl phosphite, ethyldiphenyl phosphite, phenylphosphonic acid, methylphosphonic acid, ethylphosphonic acid, potassium phenylphosphonate, sodium methylphosphonate, calcium ethylphosphonate, or combinations thereof.

Embodiment 18 is a filter media structure of any one of the preceding embodiments, wherein the average fiber diameter of the second layer is less than 0.9 microns.

Embodiment 19 is a filter media structure of any one of the preceding embodiments, wherein the average fiber diameter of the second layer is less than 0.8 microns.

Embodiment 20 is a filter media structure of any one of the preceding embodiments, wherein the average fiber diameter of the second layer is less than 0.7 microns.

Embodiment 21 is a filter media structure of any one of the preceding embodiments, wherein the average fiber diameter of the second layer is from 1 nanometer to 1000 nanometers.

Embodiment 22 is a filter media structure of any one of the preceding embodiments, wherein the average fiber diameter of the second layer is from 200 nanometer to 700 nanometers.

Embodiment 23 is a filter media structure of any one of the preceding embodiments, wherein the average fiber diameter of the second layer is less than 25 microns.

Embodiment 24 is a filter media structure of any one of the preceding embodiments, wherein the average fiber diameter of the second layer is less than 5 microns.

Embodiment 25 is a filter media structure of any one of the preceding embodiments, wherein the average fiber diameter of the second layer is from 1 micron to 25 microns.

Embodiment 26 is a filter media structure of any one of the preceding embodiments, wherein the second layer has a basis weight from 10 g/m² to 50 g/m².

Embodiment 27 is a filter media structure of any one of the preceding embodiments, wherein the second layer is removable.

Embodiment 28 is a filter media structure of any one of the preceding embodiments, wherein the second layer has a water contact angle less than 90°.

Embodiment 29 is a filter media structure of any one of the preceding embodiments, wherein the second layer comprises polyamide (PA), polyethylene (PE), polypropylene (PP), polybutylene (PB), poly-4-methylpentene (PMP), polyethylene terephthalate (PET), polybutylene terephthalate (PBT), polytrimethyl terephthalate (PTT), poly (ethylene-vinyl acetate) (PEVA), polyvinyl chloride (PVC), polystyrene (PS), polymethylmethacrylate (PMMA), polytrifluorochloroethylene (PCTFE) or combinations thereof.

Embodiment 30 is a filter media structure of any one of the preceding embodiments, wherein the second layer comprises the polyamide fibers that may comprise PA-4T/4I, PA-4T/6I, PA-5T/5I, PA-6, PA-6,6, PA-6,6/6, PA-6,6/6T, PA-6T/6I, PA-6T/6I/6, PA-6T/6, PA-6T/6I/66, PA-6T/MPMDT, PA-6T/66, PA-6T/610, PA-10T/612, PA-10T/106, PA-6T/612, PA-6T/10T, PA-6T/10I, PA-9T, PA-10T, PA-12T, PA-10T/10I, PA-10T/12, PA-10T/11, PA-6T/9T, PA-6T/12T, PA-6T/10T/6I, PA-6T/6I/6, or PA-6T/61/12, or copolymers thereof, or blends, mixtures or combinations thereof.

Embodiment 31 is a filter media structure of any one of the preceding embodiments, wherein the filter media structure demonstrates a bacterial filtration efficiency greater than 90%.

Embodiment 32 is a filter media structure of any one of the preceding embodiments, wherein the filter media structure demonstrates a bacterial filtration efficiency greater than 95%.

Embodiment 33 is a filter media structure of any one of the preceding embodiments, wherein the filter media structure demonstrates a bacterial filtration efficiency greater than 98%.

Embodiment 34 is a filter media structure of any one of the preceding embodiments, wherein the filter media structure demonstrates a particulate filtration efficiency greater than 90%.

Embodiment 35 is a filter media structure of any one of the preceding embodiments, wherein the filter media structure demonstrates a particulate filtration efficiency greater than 95%.

Embodiment 36 is a filter media structure of any one of the preceding embodiments, wherein the filter media structure demonstrates a particulate filtration efficiency greater than 98%.

Embodiment 37 is a filter media structure of any one of the preceding embodiments, wherein the filter media structure as a Minimum Efficiency Reporting Value from 7 to 15.

Embodiment 38 is a filter media structure of any one of the preceding embodiments, further comprising one or more third layers.

Embodiment 39 is a filter media structure of embodiment 38, wherein at least one of the third layer is a woven, nonwoven, and/or knit layer.

Embodiment 40 is a filter media structure of embodiment 38, wherein the one or more third layers comprises a thermoplastics comprising polyester, nylon, rayon, polyamide 6, polyamide 6,6, polyethylene (PE), polypropylene (PP), polyethylene terephthalate (PET), polyethylene terephthalate glycol (PETG), co-PET, polybutylene terephthalate (PBT) polylactic acid (PLA), polytrimethylene terephthalate (PTT), or combinations thereof.

Embodiment 41 is a filter media structure of embodiment 38, wherein the one or more third layers each have a basis weight from 5 to 250 gsm.

Embodiment 42 is a filter comprising the filter media structure of any one of the preceding embodiment.

Embodiment 43 is a filter media structure of any one of the preceding embodiments, wherein the second layer is thinner than the first layer.

Embodiment 44 is a filter media structure of any one of the preceding embodiments, wherein the second layer has a thickness from 0.03 to 10 mm.

Embodiment 45 is a filter media structure of any one of the preceding embodiments, wherein the second layer is a spunbond layer.

Embodiment 46 is a filter media structure for purifying a stream comprising:

a first layer, wherein the first layer comprises a polymer, preferably polyolefin, polyester, polyurethane, polycarbonate, polystyrene, fluoropolymer, or copolymers or blends thereof;

a second layer comprising:
from 50 to 99.9 wt. % of polymer fibers, preferably polyamide fibers, based on the total weight of the second layer, preferably each having a fiber diameter from 0.01 microns to 10 microns, and
from 1 wppm to 30,000 wppm of a metallic compound comprising copper, zinc, silver or combinations thereof,

wherein at least one of the second layer demonstrates biological-reducing properties; and

a third layer having a first and second surface, wherein the second layer is adjacent to the first surface of the third layer.

Embodiment 47 is a filter media structure of embodiment 46, wherein the first layer has a basis weight of not less than 10 g/m².

Embodiment 48 is a filter media structure of any one of embodiments 46-47, wherein the first layer is an electrically-charged nonwoven web, i.e. an electret web.

Embodiment 49 is a filter media structure of any one of embodiments 46-48, wherein the first layer comprises polyethylene (PE), polypropylene (PP), polybutylene (PB), poly-4-methylpentene (PMP), polyethylene terephthalate (PET), polybutylene terephthalate (PBT), polytrimethyl terephthalate (PTT), poly (ethylene-vinyl acetate) (PEVA), polyvinyl chloride (PVC), polystyrenepolymethylmethacrylate (PMMA), polytrifluorochloroethylene (PCTFE) or combinations thereof.

Embodiment 50 is a filter media structure of any one of embodiments 46-49, wherein the average fiber diameter of the first layer is from 1 to 100 micrometers.

Embodiment 51 is a filter media structure of any one of embodiments 46-50, wherein the second layer is positioned upstream of the first layer.

Embodiment 52 is a filter media structure of any one of embodiments 46-51, wherein the second layer is positioned downstream of the first layer.

Embodiment 53 is a filter media structure of any one of embodiments 46-52, wherein the second layer comprises from 65 to 99.9 wt. % of polyamide fibers.

Embodiment 54 is a filter media structure of any one of embodiments 46-53, wherein the second layer comprises from 5 wppm to 20,000 wppm of a metallic compound.

Embodiment 55 is a filter media structure of any one of embodiments 46-54, wherein the second layer comprises from 200 wppm to 500 wppm of a metallic compound.

Embodiment 56 is a filter media structure of any one of embodiments 46-55, wherein the metallic compound comprises zinc oxide, zinc ammonium adipate, zinc acetate, zinc ammonium carbonate, zinc stearate, zinc phenyl phosphinic acid, or zinc pyrithione, or combinations thereof.

Embodiment 57 is a filter media structure of any one of embodiments 46-56, wherein the metallic compound comprises copper oxide, copper ammonium adipate, copper acetate, copper ammonium carbonate, copper stearate, copper phenyl phosphinic acid, or copper pyrithione, or combinations thereof.

Embodiment 58 is a filter media structure of any one of embodiments 46-57, wherein the metallic compound comprises silver oxide, silver ammonium adipate, silver acetate, silver ammonium carbonate, silver stearate, silver phenyl phosphinic acid, or silver pyrithione, or combinations thereof.

Embodiment 59 is a filter media structure of any one of embodiments 46-58, wherein the average fiber diameter of the second layer is less than 1 micron.

Embodiment 60 is a filter media structure of any one of embodiments 46-59, wherein the second layer comprises less than 1 wt. % of a phosphorus compound.

Embodiment 61 is a filter media structure of embodiment 60, wherein the second layer comprises from 50 wppm to 10,000 wppm of the phosphorus compound.

Embodiment 62 is a filter media structure of embodiment 60, wherein the phosphorus compound comprises benzene phosphinic acid, diphenylphosphinic acid, sodium phenylphosphinate, phosphorous acid, benzene phosphonic acid, calcium phenylphosphinate, potassium B-pentylphosphinate, methylphosphinic acid, manganese hypophosphite, sodium hypophosphite, monosodium phosphate, hypophosphorous acid, dimethylphosphinic acid, ethylphosphinic acid, diethylphosphinic acid, magnesium ethylphosphinate, triphenyl phosphite, diphenylmethyl phosphite, dimethylphenyl phosphite, ethyldiphenyl phosphite, phenylphosphonic acid, methylphosphonic acid, ethylphosphonic acid, potassium phenylphosphonate, sodium methylphosphonate, calcium ethylphosphonate, or combinations thereof.

Embodiment 63 is a filter media structure of any one of embodiments 46-62, wherein the average fiber diameter of the second layer is less than 0.9 microns.

Embodiment 64 is a filter media structure of any one of embodiments 46-63, wherein the average fiber diameter of the second layer is less than 0.8 microns.

Embodiment 65 is a filter media structure of any one of embodiments 46-64, wherein the average fiber diameter of the second layer is less than 0.7 microns.

Embodiment 66 is a filter media structure of any one of embodiments 46-65, wherein the average fiber diameter of the second layer is from 1 nanometer to 1000 nanometers.

Embodiment 67 is a filter media structure of any one of embodiments 46-66, wherein the average fiber diameter of the second layer is from 200 nanometer to 700 nanometers.

Embodiment 68 is a filter media structure of any one of embodiments 46-67, wherein the average fiber diameter of the second layer is less than 25 microns.

Embodiment 69 is a filter media structure of any one of embodiments 46-68, wherein the average fiber diameter of the second layer is less than 5 microns.

Embodiment 70 is a filter media structure of any one of embodiments 46-69, wherein the average fiber diameter of the second layer is from 1 micron to 25 microns.

Embodiment 71 is a filter media structure of any one of embodiments 46-70, wherein the second layer has a basis weight from 10 g/m² to 50 g/m².

Embodiment 72 is a filter media structure of any one of embodiments 46-71, wherein the second layer is removable.

Embodiment 73 is a filter media structure of any one of embodiments 46-72, wherein the second layer has a water contact angle less than 90°.

Embodiment 74 is a filter media structure of any one of embodiments 46-73, wherein the second layer comprises polyamide (PA), polyethylene (PE), polypropylene (PP), polybutylene (PB), poly-4-methylpentene (PMP), polyethylene terephthalate (PET), polybutylene terephthalate (PBT), polytrimethyl terephthalate (PTT), poly (ethylene-vinyl acetate) (PEVA), polyvinyl chloride (PVC), polystyrenepolymethylmethacrylate (PMMA), polytrifluorochloroethylene (PCTFE) or combinations thereof.

Embodiment 75 is a filter media structure of any one of embodiments 46-74, wherein the polyamide fibers of the second layer comprises PA-4T/4I, PA-4T/6I, PA-5T/5I, PA-6, PA-6,6, PA-6,6/6, PA-6,6/6T, PA-6T/6I, PA-6T/6I/6, PA-6T/6, PA-6T/6I/66, PA-6T/MPMDT, PA-6T/66, PA-6T/610, PA-10T/612, PA-10T/106, PA-6T/612, PA-6T/10T, PA-6T/10I, PA-9T, PA-10T, PA-12T, PA-10T/10I, PA-10T/12, PA-10T/11, PA-6T/9T, PA-6T/12T, PA-6T/10T/6I, PA-6T/6I/6, or PA-6T/61/12, or copolymers thereof, or blends, mixtures or combinations thereof.

Embodiment 76 is a filter media structure of any one of embodiments 46-75, wherein the filter media structure demonstrates a bacterial filtration efficiency greater than 90%.

Embodiment 77 is a filter media structure of any one of embodiments 46-76, wherein the filter media structure demonstrates a bacterial filtration efficiency greater than 95%.

Embodiment 78 is a filter media structure of any one of embodiments 46-77, wherein the filter media structure demonstrates a bacterial filtration efficiency greater than 98%.

Embodiment 79 is a filter media structure of any one of embodiments 46-78, wherein the filter media structure demonstrates a particulate filtration efficiency greater than 90%.

Embodiment 80 is a filter media structure of any one of embodiments 46-79, wherein the filter media structure demonstrates a particulate filtration efficiency greater than 95%.

Embodiment 81 is a filter media structure of any one of embodiments 46-80, wherein the filter media structure demonstrates a particulate filtration efficiency greater than 98%.

Embodiment 82 is a filter media structure of any one of embodiments 46-81, wherein the filter media structure as a Minimum Efficiency Reporting Value from 7 to 15.

Embodiment 83 is a filter media structure of any one of embodiments 46-82, wherein at least one of the third layer is a woven, nonwoven, and/or knit layer.

Embodiment 84 is a filter media structure of any one of embodiments 46-83, wherein the one or more third layers comprises a thermoplastics comprising polyester, nylon, rayon, polyamide 6, polyamide 6,6, polyethylene (PE), polypropylene (PP), polyethylene terephthalate (PET), polyethylene terephthalate glycol (PETG), co-PET, polybutylene terephthalate (PBT) polylactic acid (PLA), polytrimethylene terephthalate (PTT), or combinations thereof.

Embodiment 85 is a filter media structure of any one of embodiments 46-84, wherein the one or more third layers each have a basis weight from 5 to 250 gsm.

Embodiment 86 is a filter comprising the filter media structure of any one of embodiments 46-85.

Embodiment 87 is a filter media structure of any one of embodiments 46-86, wherein the second layer is thinner than the first layer.

Embodiment 88 is a filter media structure of any one of embodiments 46-87, wherein the second layer has a thickness from 0.03 to 10 mm.

Embodiment 89 is a filter media structure of any one of embodiments 46-88, wherein the second layer is a spunbond layer.

Embodiment 90 is a filter media structure for purifying a stream comprising:

a first layer that is an electrically-charged nonwoven web having a first surface and second surface, wherein the first layer comprises a polymer, preferably polyolefin, polyester, polyurethane, polycarbonate, polystyrene, fluoropolymer, or copolymers or blends thereof; and

a second layer adjacent to the first surface, wherein second layer comprises:
from 50 to 99.9 wt. % of polymer fibers, based on the total weight of the second layer, each having a fiber diameter from 0.01 microns to 10 microns, and
from 1 wppm to 30,000 wppm of a metallic compound comprising copper, zinc, or silver, or combinations thereof, and

wherein at least one of the second layer demonstrates biological-reducing properties.

Embodiment 91 is a filter media structure for purifying a stream comprising:

a first layer having a first surface and second surface, wherein the first layer comprises a polymer, preferably polyolefin, polyester, polyurethane, polycarbonate, polystyrene, fluoropolymer, or copolymers or blends thereof; and

a second layer adjacent to the first surface, wherein second layer is a spunbond layer that comprises:
from 50 to 99.9 wt. % of polymer fibers, based on the total weight of the second layer, and
from 1 wppm to 30,000 wppm of a metallic compound comprising copper, zinc, or silver, or combinations thereof, and

wherein at least one of the second layer demonstrates biological-reducing properties.

We claim:

1. A filter media structure for purifying a stream comprising:
a first layer having a first surface and second surface, wherein the first layer comprises a polymer, preferably polyolefin, polyester, polyurethane, polycarbonate, polystyrene, fluoropolymer, or copolymers or blends thereof; and
a second layer adjacent to the first surface, wherein second layer comprises:
from 50 to 99.9 wt. % of polymer fibers, based on the total weight of the second layer, each having a fiber diameter from 0.01 microns to 10 microns, and
from 1 wppm to 30,000 wppm of a metallic compound comprising copper, zinc, or silver, or combinations thereof, and
wherein at least one of the second layer demonstrates biological-reducing properties.

2. The filter media structure of claim 1, wherein the first layer is an electrically-charged nonwoven web.

3. The filter media structure of claim 1, wherein the first layer comprises polyethylene (PE), polypropylene (PP), polybutylene (PB), poly-4-methylpentene (PMP), polyethylene terephthalate (PET), polybutylene terephthalate (PBT), polytrimethyl terephthalate (PTT), poly (ethylene-vinyl acetate) (PEVA), polyvinyl chloride (PVC), polystyrenepolymethylmethacrylate (PMMA), polytrifluorochloroethylene (PCTFE) or combinations thereof.

4. The filter media structure of claim 1, wherein the second layer is positioned upstream of the first layer.

5. The filter media structure of claim 1, wherein the second layer is positioned downstream of the first layer.

6. The filter media structure of claim 1, wherein the second layer comprises from 65 to 99.9 wt. % of polyamide fibers.

7. The filter media structure of claim 1, wherein the metallic compound comprises zinc oxide, zinc ammonium adipate, zinc acetate, zinc ammonium carbonate, zinc stearate, zinc phenyl phosphinic acid, or zinc pyrithione, or combinations thereof.

8. The filter media structure of claim 1, wherein the metallic compound comprises copper oxide, copper ammonium adipate, copper acetate, copper ammonium carbonate, copper stearate, copper phenyl phosphinic acid, or copper pyrithione, or combinations thereof.

9. The filter media structure of claim 1, wherein the metallic compound comprises silver oxide, silver ammonium adipate, silver acetate, silver ammonium carbonate, silver stearate, silver phenyl phosphinic acid, or silver pyrithione, or combinations thereof.

10. The filter media structure of claim 1, wherein the average fiber diameter of the second layer is less than 1 micron.

11. The filter media structure of claim 1, wherein the second layer comprises less than 1 wt. % of a phosphorus compound.

12. The filter media structure of claim 11, wherein the phosphorus compound comprises benzene phosphinic acid, diphenylphosphinic acid, sodium phenylphosphinate, phosphorous acid, benzene phosphonic acid, calcium phenylphosphinate, potassium B-pentylphosphinate, methylphosphinic acid, manganese hypophosphite, sodium hypophosphite, monosodium phosphate, hypophosphorous acid, dimethylphosphinic acid, ethylphosphinic acid, diethylphosphinic acid, magnesium ethylphosphinate, triphenyl phosphite, diphenylmethyl phosphite, dimethylphenyl phosphite, ethyldiphenyl phosphite, phenylphosphonic acid, methylphosphonic acid, ethylphosphonic acid, potassium phenylphosphonate, sodium methylphosphonate, calcium ethylphosphonate, or combinations thereof.

13. The filter media structure of claim 1, wherein the second layer has a water contact angle less than 90°.

14. The filter media structure of claim 1, wherein the second layer comprises polyamide fibers, wherein the polyamide fibers comprise PA-4T/4I, PA-4T/6I, PA-5T/5I, PA-6, PA-6,6, PA-6,6/6, PA-6,6/6T, PA-6T/6I, PA-6T/6I/6, PA-6T/6, PA-6T/6I/66, PA-6T/MPMDT, PA-6T/66, PA-6T/610, PA-10T/612, PA-10T/106, PA-6T/612, PA-6T/10T, PA-6T/10I, PA-9T, PA-10T, PA-12T, PA-10T/10I, PA-10T/12, PA-10T/11, PA-6T/9T, PA-6T/12T, PA-6T/10T/6I, PA-6T/6I/6, or PA-6T/61/12, or copolymers thereof, or blends, mixtures or combinations thereof.

15. The filter media structure of claim 1, wherein the filter media structure demonstrates a bacterial filtration efficiency greater than 90% and/or a particulate filtration efficiency greater than 90%.

16. A filter media structure for purifying a stream comprising:
a first layer that is an electrically-charged nonwoven web having a first surface and second surface, wherein the first layer comprises a polymer, preferably polyolefin, polyester, polyurethane, polycarbonate, polystyrene, fluoropolymer, or copolymers or blends thereof; and
a second layer adjacent to the first surface, wherein second layer comprises:
from 50 to 99.9 wt. % of polymer fibers, based on the total weight of the second layer, each having a fiber diameter from 0.01 microns to 10 microns, and
from 1 wppm to 30,000 wppm of a metallic compound comprising copper, zinc, or silver, or combinations thereof, and
wherein at least one of the second layer demonstrates biological-reducing properties.

17. The filter media structure of claim 16, wherein the filter media structure demonstrates a bacterial filtration efficiency greater than 90% and/or a particulate filtration efficiency greater than 90%.

18. A filter media structure for purifying a stream comprising:
a first layer having a first surface and second surface, wherein the first layer comprises a polymer, preferably polyolefin, polyester, polyurethane, polycarbonate, polystyrene, fluoropolymer, or copolymers or blends thereof; and
a second layer adjacent to the first surface, wherein second layer is a spunbond layer that comprises:
from 50 to 99.9 wt. % of polymer fibers, based on the total weight of the second layer, and
from 1 wppm to 30,000 wppm of a metallic compound comprising copper, zinc, or silver, or combinations thereof, and
wherein at least one of the second layer demonstrates biological-reducing properties.

19. The filter media structure of claim 18, wherein the second layer comprises polyamide fibers, wherein the polyamide fibers comprise PA-4T/4I, PA-4T/6I, PA-5T/5I, PA-6, PA-6,6, PA-6,6/6, PA-6,6/6T, PA-6T/6I, PA-6T/6I/6, PA-6T/6, PA-6T/6I/66, PA-6T/MPMDT, PA-6T/66, PA-6T/610, PA-10T/612, PA-10T/106, PA-6T/612, PA-6T/10T, PA-6T/10I, PA-9T, PA-10T, PA-12T, PA-10T/10I, PA-10T/12, PA-10T/11, PA-6T/9T, PA-6T/12T, PA-6T/10T/6I, PA-6T/6I/6, or PA-6T/61/12, or copolymers thereof, or blends, mixtures or combinations thereof.

20. The filter media structure of claim 18, wherein the filter media structure demonstrates a bacterial filtration efficiency greater than 90% and/or a particulate filtration efficiency greater than 90%.
